(19) United States
(12) Patent Application Publication
(10) Pub. No.: US 2017/0279577 A1
(43) Pub. Date: Sep. 28, 2017

(54) ASSIGNING UNIQUE TEMPORAL DELAYS TO SIGNAL PATHS ASSIGNED TO REMOTE UNITS IN A WIRELESS DISTRIBUTION SYSTEM (WDS), PARTICULARLY FOR SUPPORTING LOCATION SERVICES FOR CLIENT DEVICES

(71) Applicant: Corning Optical Communications Wireless Ltd, Airport City (IL)

(72) Inventor: Parwiz Shekalim, Netanya (IL)

(21) Appl. No.: 15/281,808

(22) Filed: Sep. 30, 2016

Related U.S. Application Data
(60) Provisional application No. 62/312,192, filed on Mar. 23, 2016.

(51) Int. Cl. H04L 5/00; H04W 72/00; H04W 4/06

(52) U.S. Cl. CPC H04L 5/0035; H04W 4/06; H04W 72/005; H04L 65/60

(57) ABSTRACT

Embodiments of the disclosure relate to assigning unique temporal delays to signal paths assigned to remote units in a wireless distribution system (WDS). In one aspect, each remote unit in a WDS is assigned a unique identification temporal delay. Each uplink and/or downlink communications signal is delayed for a respective assigned unique identification temporal delay. By examining a respective assigned unique identification temporal delay of an uplink and/or downlink communications signal, it is possible to uniquely identify the remote unit from which the uplink and/or downlink communications signal is communicated. In another aspect, the unique identification temporal delays assigned to any pair of adjacent remote units differ by more than one predefined timing advance (TA) step. By separating the unique identification temporal delays between adjacent remote units by more than one predefined TA step, it is possible to improve reliability in uniquely identifying a plurality of remote units.

### PRIORITY APPLICATIONS

This application claims the benefit of priority under 35 U.S.C. §119 of U.S. Provisional Application No. 62/312,192, filed on Mar. 23, 2016, the content of which is relied upon and incorporated herein by reference in its entirety.

### BACKGROUND

The disclosure relates generally to a wireless distribution system (WDS), and more particularly, to assigning unique temporal delays to signal paths assigned to remote units in a WDS.

Wireless customers are increasingly demanding digital data services, such as streaming video and other multimedia contents, for example. Some wireless customers use their wireless devices in areas poorly serviced by conventional cellular networks, such as inside certain buildings or areas. One response to the intersection of these two concerns has been the use of WDSs, such as a distributed antenna system (DAS) as an example. A DAS can be particularly useful when deployed inside buildings or other indoor environments where client devices may not otherwise be able to effectively receive radio frequency (RF) signals from a base transceiver station (BTS), for example, of a conventional cellular network. The DAS is configured to provide multiple coverage areas inside the buildings to support higher capacity and improved RF coverage. Each coverage area includes one or more remote units configured to provide communications services to the client devices within antenna ranges of the remote units.

Many context-aware and location-aware wireless services, such as enhanced 911 (E911) services, rely on accurately detecting the locations of wireless communications devices. A satellite-based location detection system, such as global positioning system (GPS) in the United States, is unreliable in indoor environments served by the DASs due to the inherent inability of a satellite signal to penetrate obstacles like building walls. Although it may be possible to determine general locations of wireless communications devices based on base stations in the convention cellular network, it remains challenging for base stations to pinpoint the locations of the wireless communications devices with a higher degree of accuracy.

No admission is made that any reference cited herein constitutes prior art. Applicant expressly reserves the right to challenge the accuracy and pertinency of any cited documents.

### SUMMARY

Embodiments of the disclosure relate to assigning unique temporal delays to signal paths assigned to remote units in a wireless distribution system (WDS), particularly for supporting location services for client devices. In this regard, the WDS comprises a plurality of remote units configured to distribute received downlink communications signals to client devices (e.g., mobile cellular devices) in the antenna coverage area of the remote units, and distribute received uplink communications signals from client devices to a network (e.g., a cellular network). In one exemplary aspect, the plurality of remote units is each assigned a unique identification temporal delay. Received communications signals, including the received downlink communications signals and/or the received uplink communications signals, communicated by the remote units are delayed according to the respective assigned unique identification temporal delay for the remote unit. By examining the delay of received communications signals in the WDS and associating the delay with a unique temporal delay assigned to the remote units, it is possible to uniquely identify the remote unit from which the received communications signal is communicated. In this regard, the location of client devices in the WDS relative to the remote units can be determined.

Further, to mitigate uplink propagation delay drifts resulting from factors inherent to wireless communications systems (e.g., multipath) causing inaccuracies in determining the plurality of remote units based on the assigned unique temporal delays, in another aspect, the unique identification temporal delays assigned to adjacent remote units differ by more than one predefined timing advance (TA) step. A TA step is a time duration designed to accommodate propagation delays in a specific communications system, such as long-term evolution (LTE) for example. Remote units are determined to be adjacent to each other if remote units are separated by a TA-defined distance that a client device can traverse at a predefined velocity (e.g., nomadic velocity) within a predefined interval. By separating the unique identification temporal delays assigned to adjacent remote units by more than one predefined TA step, it is possible to tolerate propagation variations resulting from factors inherent to wireless communications systems (e.g., multipath), thus improving reliability in uniquely identifying a plurality of remote units in the WDS.

One embodiment of the disclosure relates to a WDS. The WDS comprises a central unit. The central unit is configured to communicate a plurality of downlink communications signals over a plurality of downlink signal paths to a plurality of remote units in the WDS, respectively. The central unit is also configured to receive a plurality of uplink communications signals over a plurality of uplink signal paths assigned to the plurality of remote units, the plurality of assigned uplink signal paths disposed respectively between the central unit and the plurality of remote units. The WDS also comprises a plurality of delay elements provided in a plurality of signal paths among the plurality of downlink signal paths and the plurality of uplink signal paths and assigned to the plurality of remote units, respectively. Each of the plurality of delay elements is configured to delay a respective communications signal communicated on a respective assigned signal path by an assigned unique identification temporal delay that differs from at least one assigned unique identification temporal delay assigned to at least one adjacent remote unit among the plurality of remote units by more than one predefined TA step. An adjacent remote unit is a remote unit physically located from another remote unit among the plurality of remote units within a TA-defined distance that a client device can traverse at a predefined velocity within a predefined interval.

An additional embodiment of the disclosure relates to a method for identifying a plurality of remote units in a WDS. The method comprises communicating a plurality of downlink communications signals over a plurality of downlink signal paths to the plurality of remote units in the WDS, respectively. The method also comprises receiving a plurality of uplink communications signals over a plurality of uplink signal paths assigned to the plurality of remote units. The method also comprises delaying each of a plurality of communications signals among the plurality of downlink communications signals and the plurality of uplink communications signals by an assigned unique identification temporal delay that differs from at least one assigned unique identification temporal delay assigned to at least one adjacent remote unit among the plurality of remote units by more than one predefined TA step.

An additional embodiment of the disclosure relates to a WDS. The WDS comprises a central unit. The central unit is configured to communicate one or more first downlink communications signals over one or more first downlink signal paths to one or more first remote units in at least one first remote unit cluster, respectively. The central unit is also configured to communicate one or more second downlink communications signals over one or more second downlink signal paths to one or more second remote units in at least one second remote unit cluster, respectively. The central unit is also configured to receive one or more first uplink communications signals over one or more first uplink signal paths assigned to the one or more first remote units, the one or more assigned first uplink signal paths disposed respectively between the central unit and the one or more first remote units. The central unit is also configured to receive one or more second uplink communications signals over one or more second uplink signal paths assigned to the one or more second remote units, the one or more assigned second uplink signal paths disposed respectively between the central unit and the one or more second remote units. The WDS also comprises one or more first delay elements provided in the one or more first uplink signal paths and assigned to the one or more first remote units, respectively. The WDS also comprises one or more second delay elements provided in the one or more second uplink signal paths and assigned to the one or more second remote units, respectively.

Each of the one or more first delay elements is configured to delay a respective first uplink communications signal communicated over a respective assigned first uplink signal path by a respective assigned first unique identification temporal delay that differs from at least one assigned first unique identification temporal delay assigned to at least one other first remote unit in the at least one first remote unit cluster by more than one predefined TA step. Each of the one or more second delay elements is configured to delay a respective second uplink communications signal communicated over a respective assigned second uplink signal path by a respective assigned second unique identification temporal delay that differs from at least one assigned second unique identification temporal delay assigned to at least one other second remote unit in the at least one second remote unit cluster by more than one predefined TA step. The at least one first remote unit cluster is separated from the at least one second remote unit cluster by at least a TA-defined distance that a client device is unable to traverse at a predefined velocity within a predefined interval. An assigned first unique identification temporal delay assigned to a first remote unit in the at least one first remote unit cluster differs from an assigned second unique identification temporal delay assigned to a second remote unit in the at least one second remote unit cluster by less than two predefined TA steps.

An additional embodiment of the disclosure relates to a method for assigning unique identification temporal delays to remote units in a WDS. The method comprises determining at least one first remote unit cluster comprising one or more first remote units. The method also comprises determining at least one second remote unit cluster comprising one or more second remote units, wherein the at least one second remote unit cluster is separated from the at least one first remote unit cluster by a TA-defined distance that a client device is unable to traverse at a predefined velocity within a predefined interval. The method also comprises logically organizing the one or more first remote units in the at least one first remote unit cluster into a first sequential queue. The method also comprises selecting a beginning first remote unit at a head of the first sequential queue and assigning the beginning first remote unit an assigned first unique identification temporal delay that is greater than or equal to one predefined TA step. The method also comprises assigning a respective assigned first unique identification temporal delay that differs from a respective assigned first unique identification temporal delay of an immediate preceding first remote unit in the first sequential queue by more than one predefined TA step for each first remote unit subsequent to the beginning first remote unit in the first sequential queue.

The method also comprises logically organizing the one or more second remote units in the at least one second remote unit cluster into a second sequential queue. The method also comprises selecting a beginning second remote unit at a head of the second sequential queue and assigning the beginning second remote unit an assigned second unique identification temporal delay that differs from the assigned first unique identification temporal delay of the beginning first remote unit in the first sequential queue by at least one predefined TA step. The method also comprises assigning a respective assigned second unique identification temporal delay that differs from a respective assigned second unique identification temporal delay of an immediate preceding second remote unit in the second sequential queue by more than one predefined TA step for each second remote unit subsequent to the beginning second remote unit in the second sequential queue.

Additional features and advantages will be set forth in the detailed description which follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding of the disclosure, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary distributed antenna system (DAS);

FIG. 2 is a schematic diagram of an exemplary wireless distribution system (WDS) in which a plurality of remote units are each uniquely identified by a plurality of assigned unique identification temporal delays for determining location of client devices in the WDS relative to the location of the remote units;

FIG. 3 is a schematic diagram of an exemplary first remote unit and an exemplary second remote unit in a WDS that are determined to be adjacent remote units based on the remote units being physically located from each other within a timing advance (TA);

FIG. 4 is a schematic diagram of another exemplary WDS in which adjacent remote units among a plurality of remote units are assigned unique identification temporal delays that are separated between each other by more than one predefined TA step to tolerate propagation variations when uniquely identifying remote units in the WDS based on temporal delays in received uplink communications signals;

FIG. 5 is a flowchart of an exemplary remote unit identification process that may be employed to identify the plurality of remote units in the WDS of FIG. 4 by associating the delay of uplink communications signals with unique temporal delays assigned to the remote units;

FIG. 6 is a schematic diagram of another exemplary WDS in which at least one first remote unit cluster and at least one second remote unit cluster are separated by a TA-defined distance that makes the first remote unit cluster and the second remote unit cluster non-adjacent remote unit clusters;

FIG. 7 is a flowchart of an exemplary remote unit identification process that may be employed to identify one or more first remote unit clusters and one or more second remote unit clusters in the WDS of FIG. 6 by associating the delay of communications signals with unique temporal delays assigned to the remote units;

FIG. 8 is a schematic diagram of an exemplary WDS in which a central unit is configured to locate any client device relative to a determined radius from a remote unit in a WDS, such as the WDSs in FIGS. 2, 4, and 6 as examples;

FIG. 9 is a schematic diagram of an exemplary optical-fiber based WDS that includes adjacent remote units that can be assigned unique identification temporal delay that differ from each other by more than one predefined TA step, to tolerate propagation variations when uniquely identifying remote units in the optical-fiber based WDS;

FIG. 10 is a partial schematic cut-away diagram of an exemplary building infrastructure in which the WDSs of FIGS. 2, 4, and 6 can be employed; and

FIG. 11 is a schematic diagram of a generalized representation of an exemplary controller that can be included in the WDS of FIG. 4 to identify the plurality of remote units and in the WDS of FIG. 6 to identify remote units in the at least one first remote unit cluster and the at least one second remote unit cluster, wherein an exemplary computer system is adapted to execute instructions from an exemplary computer-readable medium.

### DETAILED DESCRIPTION

Embodiments of the disclosure relate to assigning unique temporal delays to signal paths assigned to remote units in a wireless distribution system (WDS), particularly for supporting location services for client devices. In this regard, the WDS comprises a plurality of remote units configured to distribute received downlink communications signals to client devices (e.g., mobile cellular devices) in the antenna coverage area of the remote units, and distribute received uplink communications signals from client devices to a network (e.g., a cellular network). In one exemplary aspect, the plurality of remote units is each assigned a unique identification temporal delay. Received communications signals, including the received downlink communications signals and/or the received uplink communications signals, communicated by the remote units are delayed according to the respective assigned unique identification temporal delay for the remote unit. By examining the delay of received communications signals in the WDS and associating the delay with a unique temporal delay assigned to the remote units, it is possible to uniquely identify the remote unit from which the received communications signal is communicated. In this regard, the location of client devices in the WDS relative to the remote units can be determined.

Further, to mitigate uplink propagation delay drifts resulting from factors inherent to wireless communications systems (e.g., multipath) causing inaccuracies in determining the plurality of remote units based on the assigned unique temporal delays, in another aspect, the unique identification temporal delays assigned to adjacent remote units differ by more than one predefined timing advance (TA) step. A TA step is a time duration designed to accommodate propagation delays in a specific communications system, such as long-term evolution (LTE) for example. Remote units are determined to be adjacent to each other if remote units are separated by a TA-defined distance that a client device can traverse at a predefined velocity (e.g., nomadic velocity) within a predefined interval. By separating the unique identification temporal delays assigned to adjacent remote units by more than one predefined TA step, it is possible to tolerate propagation variations resulting from factors inherent to wireless communications systems (e.g., multipath), thus improving reliability in uniquely identifying a plurality of remote units in the WDS.

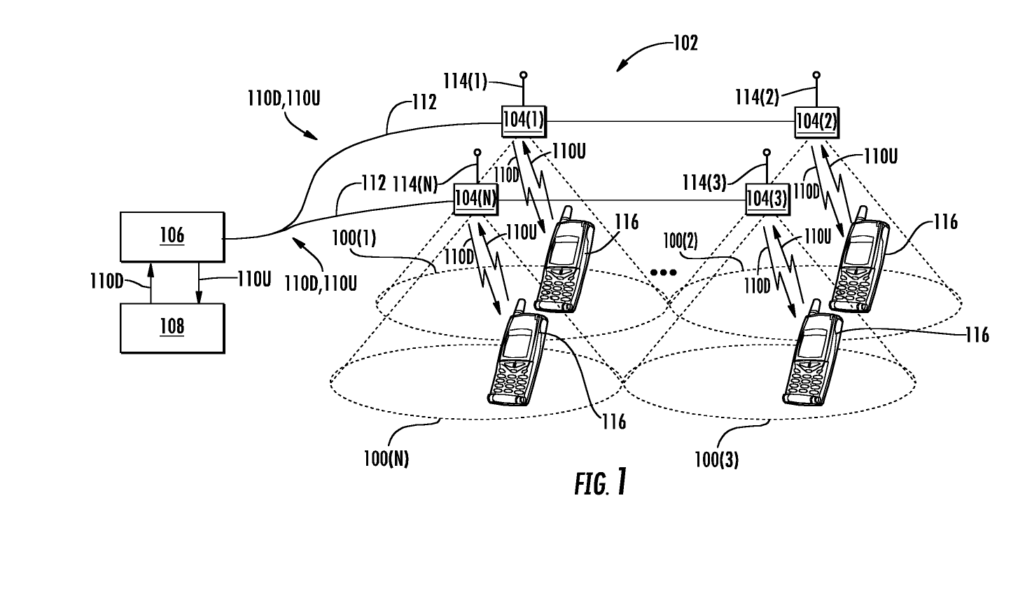

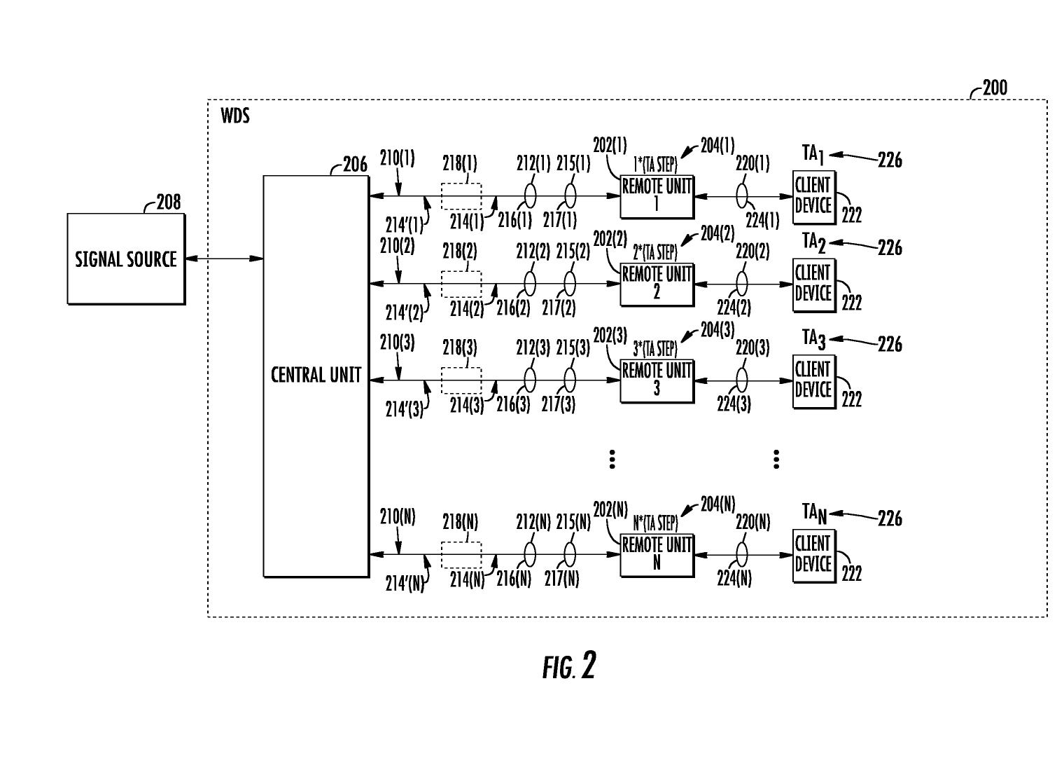

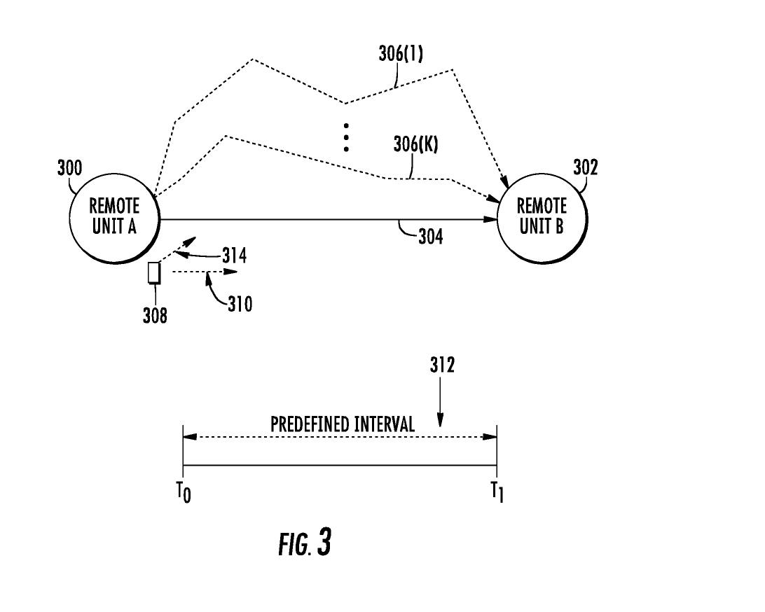

Before discussing examples of identifying remote units in WDSs starting at FIG. 3, a discussion of an exemplary DAS that employs a communications medium to support wireless communications services to a plurality of remote units is first provided with reference to FIG. 1. The discussion of specific exemplary aspects of identifying remote units in WDSs starts at FIG. 2.

In this regard, FIG. 1 illustrates distribution of communications services to remote coverage areas 100(1)-100(N) of a WDS 102, such as a distributed antenna system (DAS) for example. These communications services can include cellular services, wireless services, such as radio frequency identification (RFID) tracking, Wireless Fidelity (Wi-Fi), local area network (LAN), and wireless LAN (WLAN), worldwide interoperability for microwave access (WiMAX), wide-band code-division multiple access (WCDMA), long-term evolution (LTE), and combinations thereof, as examples. The remote coverage areas 100(1)-100(N) may be remotely located. In this regard, the remote coverage areas 100(1)-100(N) are created by and centered on remote units 104(1)-104(N) (e.g., remote antenna units) connected to a central unit 106 (e.g., a head-end controller, a head-end unit, or a head-end equipment). The central unit 106 may be communicatively coupled to a signal source 108, for example, a base transceiver station (BTS) or a baseband unit (BBU). In this regard, the central unit 106 receives downlink communications signals 110D from the signal source 108 to be distributed to the remote units 104(1)-104(N). The remote units 104(1)-104(N) are configured to receive the downlink communications signals 110D from the central unit 106 over a communications medium 112 to be distributed to the respective remote coverage areas 100(1)-100(N) of the remote units 104(1)-104(N). In a non-limiting example, the communications medium 112 may be a wired communications medium, a wireless communications medium, or an optical fiber-based communications medium. Each of the remote units 104(1)-104(N) may include an RF transmitter/receiver (not shown) and a respective antenna 114(1)-114(N) operably connected to the RF transmitter/receiver to wirelessly distribute the communications services to client devices 116 within the respective remote coverage areas 100(1)-100(N). The remote units 104(1)-104(N) are also configured to receive uplink communications signals 110U from the client devices 116 in the respective remote coverage areas 100(1)-100(N) to be distributed to the signal source 108. The size of each of the remote coverage areas 100(1)-100(N) is determined by the amount of RF power transmitted by the respective remote units 104(1)-104(N), receiver sensitivity, antenna gain, and RF environment, as well as by RF transmitter/receiver sensitivity of the client devices 116. The client devices 116 usually have a fixed maximum RF receiver sensitivity, so that the above-mentioned properties of the remote units 104(1)-104(N) mainly determine the size of the respective remote coverage areas 100(1)-100(N).

With reference to FIG. 1, in one non-limiting example, the client devices 116 may be located in the WDS 102 based on the remote units 104(1)-104(N). To be able to locate the client devices 116 based on the remote units 104(1)-104(N), it is necessary to uniquely identify the remote units 104(1)-104(N) in the WDS 102. Moreover, it may be desired to uniquely identify the remote units 104(1)-104(N) in the WDS 102 based on non-intrusive methods. In this regard, FIG. 2 is a schematic diagram of an exemplary WDS 200 in which a plurality of remote units 202(1)-202(N) is uniquely identified by a plurality of assigned unique identification temporal delays 204(1)-204(N), respectively.

With reference to FIG. 2, the WDS 200 includes a central unit 206 communicatively coupled to at least one signal source 208 (e.g., BTS, evolution node B (eNB), etc.). The central unit 206 is configured to communicate a plurality of downlink communications signals 210(1)-210(N) over a plurality of downlink signal paths 212(1)-212(N) to the remote units 202(1)-202(N), respectively. The central unit 206 is also configured to receive a plurality of uplink communications signals 214(1)-214(N). Collectively, the downlink communications signals 210(1)-210(N) and the uplink communications signals 214(1)-214(N) are also referred to as a plurality of communications signals 215(1)-215(N). The central unit 206 receives the uplink communications signals 214(1)-214(N) over a plurality of uplink signal paths 216(1)-216(N) from the remote units 202(1)-202(N), respectively. The downlink signal paths 212(1)-212(N) and the uplink signal paths 216(1)-216(N) are disposed between the remote units 202(1)-202(N) and the central unit 206. Collectively, the downlink signal paths 212(1)-212(N) and the uplink signal paths 216(1)-216(N) are also referred to as a plurality of signal paths 217(1)-217(N).

The WDS 200 also includes a plurality of delay elements 218(1)-218(N) provided in the signal paths 217(1)-217(N) and assigned to the remote units 202(1)-202(N), respectively. Each of the delay elements 218(1)-218(N) is configured to delay a respective communications signal among the communications signals 215(1)-215(N) by a respective assigned unique identification temporal delay 204(1)-204(N). In a first non-limiting example, the delay elements 218(1)-218(N) are provided in the downlink signal paths 212(1)-212(N), respectively. In this regard, each of the delay elements 218(1)-218(N) is configured to delay a respective downlink communications signal among the downlink communications signals 210(1)-210(N) by the respective assigned unique identification temporal delay among the assigned unique identification temporal delays 204(1)-204(N). In a second non-limiting example, the delay elements 218(1)-218(N) are provided in the uplink signal paths 216(1)-216(N). In this regard, each of the delay elements 218(1)-218(N) is configured to delay a respective uplink communications signal among the uplink communications signals 214(1)-214(N) by the respective assigned unique identification temporal delay among the assigned unique identification temporal delays 204(1)-204(N). In a third non-limiting example, the delay elements 218(1)-218(N) are provided in both the downlink signal paths 212(1)-212(N) and the uplink signal paths 216(1)-216(N), respectively.

In this regard, each of the delay elements 218(1)-218(N) is configured to delay the respective downlink communications signal among the downlink communications signals 210(1)-210(N) and the respective uplink communications signal among the uplink communications signals 214(1)-214(N) by the respective assigned unique identification temporal delay among the assigned unique identification temporal delays 204(1)-204(N). As such, the central unit 206 and/or the signal source 208 will receive a plurality of delayed uplink communications signals 214′(1)-214′(N). The delayed uplink communications signals 214′(1)-214′(N) are the same as the uplink communications signals 214(1)-214(N), but are delayed by the delay elements 218(1)-218(N) according to the assigned unique identification temporal delays 204(1)-204(N). In this regard, according to the first non-limiting example discussed above, the assigned unique identification temporal delays 204(1)-204(N) associated with the delayed uplink communications signals 214′(1)-214′(N) are provided in the downlink signal paths 212(1)-212(N). Similarly, according to the second non-limiting example discussed above, the assigned unique identification temporal delays 204(1)-204(N) associated with the delayed uplink communications signals 214′(1)-214′(N) are provided in the uplink signal paths 216(1)-216(N). Likewise, according to the third non-limiting example discussed above, the assigned unique identification temporal delays 204(1)-204(N) associated with the delayed uplink communications signals 214′(1)-214′(N) are provided in both the downlink signal paths 212(1)-212(N) and the uplink signal paths 216(1)-216(N). As is further discussed next, the central unit 206 and/or the signal source 208 can analyze the delayed uplink communications signals 214′(1)-214′(N) to determine the assigned unique identification temporal delays 204(1)-204(N), respectively. The central unit 206 and/or the signal source 208 can then uniquely identify the remote units 202(1)-202(N) based on the determined assigned unique identification temporal delays 204(1)-204(N).

With continuing reference to FIG. 2, the remote units 202(1)-202(N) are configured to communicate the downlink communications signals 210(1)-210(N) over a plurality of downlink wireless signal paths 220(1)-220(N), respectively. Each of the remote units 202(1)-202(N) communicates a respective downlink communications signal among the downlink communications signals 210(1)-210(N) to a respective client device 222. Although only one respective client device 222 is shown in FIG. 2 for each of the remote units 202(1)-202(N), it shall be appreciated that each of the remote units 202(1)-202(N) can communicate concurrently with more than one respective client devices 222.

The remote units 202(1)-202(N) are configured to receive the uplink communications signals 214(1)-214(N) over a plurality of uplink wireless signal paths 224(1)-224(N), respectively. Each of the remote units 202(1)-202(N) receives a respective uplink communications signal among the uplink communications signals 214(1)-214(N) from the respective client device 222.

With continuing reference to FIG. 2, each of the client devices 222 is assigned a timing advance (TA) 226 by the signal source 208. In wireless communications systems such as LTE, the TA 226 is a medium access control (MAC) control element (CE) that the signal source 208 uses to control transmission timings of the uplink communications signals 214(1)-214(N) at the client devices 222 to achieve timing synchronization with a subframe timing determined by the signal source 208. In a non-limiting example, the signal source 208 keeps measuring the timing difference between the subframe timing and uplink control signals, such as sounding reference signals (SRSs) (not shown), received from the client devices 222 on uplink control channels (e.g., physical uplink shared channel (PUSCH) or physical uplink control channel (PUCCH)) (not shown). Based on the measured timing difference, the signal source 208 can determine a round-trip propagation delay between the signal source 208 and any client device 222. Based on the determined round-trip propagation delay, the signal source 208 can assign a respective TA 226 to the client device 222 to accommodate for respective uplink propagation delay from the client device 222 to the signal source 208. In this regard, the TA 226 assigned to each of the client devices 222 accounts for one half of the determined round-trip propagation delay.

For the convenience of illustration and reference, the remote unit 202(1), the downlink communications signal 210(1), the uplink communications signal 214(1), the delayed uplink communications signal 214′(1), the uplink signal path 216(1), and the client device 222 transmitting the uplink communications signal 214(1) are discussed hereinafter as a non-limiting example. It shall be appreciated that the configuration and operation principles discussed herein are applicable to all other elements in the WDS 200.

With continuing reference to FIG. 2, the TA 226 accounts for a round-trip propagation delay between the client device 222 and the signal source 208. The client device 222 receives the downlink communications signal 210(1) from the signal source 208 over the downlink signal path 212(1) and the downlink wireless signal path 220(1). The client device 222 transmits the uplink communications signal 214(1) to the signal source 208 over the uplink wireless signal path 224(1) and the uplink signal path 216(1). As such, after the signal source 208 transmits the downlink communications signal 210(1), the uplink communications signal 214(1) can be expected to arrive at the signal source 208 after the TA 226. The TA 226 is proportionally related to the distance between the client device 222 and the signal source 208, which may be determined based on Equation 1 (Eq. 1) below.

Distance=(Round-trip Propagation Delay)×(Speed of Light in Air) (Eq. 1)

In this regard, the TA 226 is determined to be the round-trip propagation delay. As it is well known, the speed of light in air is approximately three hundred million meters per second (3×10⁸ m/s). The round-trip propagation delay, on the other hand, is typically measured in TA units. In the LTE communications systems, for example, a TA unit is defined as five hundred twenty and eight tenths nanoseconds (520.8 ns or 520.8×10⁻⁹ second). The TA 226, as discussed in the present disclosure, is based on a predefined TA step that equals the LTE TA units. According to Equation 1.1 (Eq. 1.1) below, the distance that light can traverse in air during one predefined TA step, which is hereinafter referred to as a “TA distance in air,” is approximately seventy-eight meters (78 m).

$$( Eq . 1.1 )$$

$$\begin{matrix}TA Distance in Air = ( TA ( 226 ) ) \times ( Speed of Light in Air ) \\ = ( 520.8 \times {10}^{- 9} s / 2 ) \times ( 3 \times {10}^{8} m \text{/} s ) \\ \approx 78\end{matrix}$$

However, the speed of light in an optical medium (e.g., optical fiber) is slower than the speed of light in air. In a non-limiting example, the speed of light in optical medium is approximately two hundred million meters per second (2×10⁸ m/s). In this regard, according to Equation 1.2 (Eq. 1.2) below, the distance that light can traverse in optical medium during one predefined TA step, which is hereinafter referred to as a “TA distance in optical medium,” is approximately fifty-two meters (52 m).

$$TA Distance in Optical Medium = ( TA ( 226 ) ) \times ( Speed of Light in Opitcal Medium ) = ( 520.8 \times {10}^{- 9} s / 2 ) \times ( 2 \times {10}^{8} m \text{/} s ) \approx 52 \qquad ( Eq . 1.2 )$$

As previously stated, each of the delay elements 218(1)-218(N) is configured to delay a respective downlink communications signal among the downlink communications signals 210(1)-210(N) and/or a respective uplink communications signal among the uplink communications signals 214(1)-214(N) by a respective assigned unique identification temporal delay among the assigned unique identification temporal delays 204(1)-204(N). As such, the downlink communications signals 210(1)-210(N) and/or the uplink communications signals 214(1)-214(N) are further delayed by the delay elements 218(1)-218(N) for the assigned unique identification temporal delays 204(1)-204(N), respectively, in addition to the respective TA 226. As a result, each of the delayed uplink communications signals 214′(1)-214′(N) will have a respective total delay as determined in Equation 2 (Eq. 2) below.

$$\begin{matrix}Total delay = Round \text{-} trip Propagation Delay + \\ Assigned Unique Identification Temporal \\ Delay \\ = TA + Assigned Unique Idenification \\ Temporal Delay\end{matrix} \qquad ( Eq . 2 )$$

According to previous discussions, the assigned unique identification temporal delay 204(1) may be generated by the delay element 218(1) in the downlink signal path 212(1), in the uplink signal path 216(1), or in both the downlink signal path 212(1) and the uplink signal path 216(1). In this regard, for example, the total delay of the delayed uplink communications signal 214′(1) will equal the TA 226 plus the assigned unique identification temporal delay 204(1). If the TA 226 assigned to the client device 222 is six tenths of the predefined TA step (0.6*(TA step)) and the assigned unique identification temporal delay 204(1) is equal to one predefined TA step (1*(TA step)), then the total delay of the delayed uplink communications signal 214′(1) will equal one and six tenths of the predefined TA step when the delayed uplink communications signal 214′(1) arrives at the signal source 208.

In a non-limiting example, the assigned unique identification temporal delays 204(1)-204(N) may be assigned to the remote units 202(1)-202(N) sequentially based on a one predefined TA step increment. For example, the assigned unique identification temporal delay 204(1) is equal to one predefined TA step (1*(TA step)), the assigned unique identification temporal delay 204(2) is equal to two predefined TA steps (2*(TA step)), the assigned unique identification temporal delay 204(3) is equal to three predefined TA steps (3*(TA step)), and the assigned unique identification temporal delay 204(N) is equal to N predefined TA steps (N*(TA step)).

When the signal source 208 receives the delayed uplink communications signal 214′(1), for example, the signal source 208 is aware of the TA 226 associated with the client device 222, because the signal source 208 has assigned the TA 226 to the client device 222 to accommodate for the uplink propagation delay from the client device 222. Therefore, using Equation 2 above, the signal source 208 is able to determine the assigned unique identification temporal delay 204(1) by subtracting the TA 226 from the total delay of the delayed uplink communications signal 214′(1). As a result, the signal source 208 is able to uniquely identify the remote unit 202(1) based on the determined assigned unique identification temporal delay 204(1). Hence, by determining the assigned unique identification temporal delays 204(1)-204(N) from the delayed uplink communications signals 214′(1)-214′(N), the signal source 208 can uniquely identify all of the remote units 202(1)-202(N) in the WDS 200.

With continuing reference to FIG. 2, the uplink communications signal 214(1) transmitted from the client device 222 to the remote unit 202(1) over the uplink wireless signal path 224(1) may arrive at the remote unit 202(1) through multiple paths. As a result, the uplink communications signal 214(1) may experience additional delay when arriving at the remote unit 202(1) over the uplink wireless signal path 224(1). The additional delay experienced by the uplink communications signal 214(1) may cause the uplink propagation delay to drift. Consequently, the signal source 208 may have difficulty in accurately identifying the remote unit 202(1) based on Equation 2 above.

For example, if the assigned unique identification temporal delay 204(1) assigned to the remote unit 202(1) is 1*(TA step), the assigned unique identification temporal delay 204(2) assigned to the remote unit 202(2) is 2*(TA step), and the TA 226 assigned to the client device 222 associated with the remote unit 202(1) is six tenths of the predefined TA step (0.6*(TA step)), then the total delay of the delayed uplink communications signal 214′(1), as determined based on Equation 2, is supposed to be one and six tenths of the predefined TA step (1.6*(TA step)). If the uplink communications signal 214(1) does not experience the additional delay over the uplink wireless signal path 224(1), the delayed uplink communications signal 214′(1) will arrive at the signal source 208 with the anticipated total delay of 1.6*(TA step). By subtracting the TA 226 from the total delay of the delayed uplink communications signal 214′(1), the signal source 208 can determine the assigned unique identification temporal delay 204(1) and, thus, uniquely identify the remote unit 202(1).

If the uplink communications signal 214(1) experienced an additional delay that is equal to eight tenths of the predefined TA step (0.8*(TA step)) over the uplink wireless signal path 224(1), the uplink propagation delay will increase from 0.6*(TA step) to one and four tenths of the predefined TA step (1.4*(TA step). As a result, the total delay of the delayed uplink communications signal 214′(1) will increase from 1.6*(TA step) to be equal to two and four tenths of the predefined TA step (2.4*(TA step)). The signal source 208, however, still considers the uplink propagation delay as being equal to the TA 226 that equals 0.6*(TA step). By subtracting the TA 226 from the total delay of the delayed uplink communications signal 214′(1), which now stands at 2.4*(TA step), the signal source 208 will determine the assigned unique identification temporal delay 204(1) as being one and eight tenths of the predefined TA step (2.4*(TA step)−0.6*(TA step)=1.8*(TA step)). Since the assigned unique identification temporal delays 204(1)-204(2) of the remote units 202(1)-202(2) are 1*(TA step) and 2*(TA step), respectively, the signal source 208 will have difficulty definitively identifying either the remote unit 202(1) or the remote unit 202(2) based on the determined assigned unique identification temporal delay of 1.8*(TA step). Further, if the determined assigned unique identification temporal delay is mathematically rounded up to a closest multiple of the predefined TA step, for example two predefined TA steps (2*(TA step)), the signal source 208 may misidentify the remote unit 202(2) based on the rounded-up assigned unique identification temporal delay. Hence, it may be desired to enhance the WDS 200 to ensure unambiguous identification of the remote units 202(1)-202(N).

In this regard, it may be necessary to determine adjacencies between the remote units 202(1)-202(N) before assigning the assigned unique identification temporal delays 204(1)-204(N). FIG. 3 is a schematic diagram of an exemplary first remote unit 300 and an exemplary second remote unit 302 that are determined to be adjacent remote units. As will be discussed in more detail below, to mitigate uplink propagation delay drifts resulting from factors inherent to wireless communications systems (e.g., multipath) causing inaccuracies in determining the remote units based on the assigned unique temporal delays, in another aspect, the unique identification temporal delays assigned to adjacent remote units differ by more than one predefined TA step. Remote units are determined to be adjacent to each other if remote units are separated by a TA-defined distance that a client device can traverse at a predefined velocity (e.g., nomadic velocity) within a predefined interval. By separating the unique identification temporaldelays assigned to adjacent remote units by more than one predefined TA step, it is possible to tolerate propagation variations resulting from factors inherent to wireless communications systems (e.g., multipath), thus improving reliability in uniquely identifying a plurality of remote units in the WDS.

In this regard, with reference to FIG. 3, the adjacency between the first remote unit 300 and the second remote 302 may be defined based on a TA-defined distance between the first remote unit 300 and the second remote unit 302. The TA-defined distance corresponds to the shortest travel path between the first remote unit 300 and the second remote unit 302. In a first non-limiting example, if the first remote unit 300 and the second remote unit 302 are not separated by physical obstacles (e.g., cubicles, walls, floors, ceilings, etc.), the TA-defined distance will be determined by a point-to-point path 304 between the first remote unit 300 and the second remote unit 302. In a second non-limiting example, if the first remote unit 300 and the second remote unit 302 are separated by physical obstacles, the TA-defined distance may be determined based one of a plurality of possible travel paths 306(1)-306(K). In a non-limiting example, as shown in Equation 3 (Eq. 3) below, the TA-defined distance is an integer multiple of the TA distance in air.

TA-defined Distance=N×(TA distance in Air) (N=1, 2, 3 . . . ) (Eq. 3)

Once the TA-defined distance between the first remote unit 300 and the second remote unit 302 is determined, it is possible to define whether the first remote unit 300 is adjacent to the second remote unit 302. In this regard, the first remote unit 300 is adjacent to the second remote unit 302 if a client device 308 is able to traverse the TA-defined distance at a predefined velocity 310 and within a predefined interval 312. In contrast, the first remote unit 300 is non-adjacent to the second remote unit 302 if the client device 308 is unable to traverse the TA-defined distance at the predefined velocity 310 and within the predefined interval 312.

In a non-limiting example, the predefined velocity 310 may be a pedestrian velocity (also referred to herein as pedestrian velocity 310) that is up to three (3) miles per hour (mph), or 1.3 meters per second (m/s). In another non-limiting example, the predefined velocity 310 may be a nomadic velocity (also referred to herein as nomadic velocity 310) that is up to 5 mph, or approximately 2.2 m/s. The predefined interval 312, on the other hand, may be an interval between two consecutive examinations of an uplink communications signal 314 transmitted by the client device 308. For example, if a first examination and a second examination of the uplink communications signal 314 occur at times T₀ and T₁, respectively, the predefined interval 312 will then be equal to time T₁ minus time T₀ (T₁−T₀).

With continuing reference to FIG. 3, for example, if the client device 308 is moving at the pedestrian velocity 310 of 1.3 m/s and the predefined interval 312 is fifty (50) seconds (s), the client device 308 will be able to travel sixty-five (65) meters (m) during the predefined interval 312. In this regard, if the TA-related distance between the first remote unit 300 and the second remote unit 302 is one TA distance in air (78 m in this example), the first remote unit 300 and the second remote unit 302 are not adjacent because the client device 308 is unable to traverse the TA-defined distance at the pedestrian velocity 310 and within the predefined interval 312 of 50 s.

However, if the client device 308 is moving at the nomadic velocity 310 of 2.2 m/s and the predefined interval 312 remains as 50 s, then the client device 308 will be able to traverse one hundred ten meters (110 m) during the predefined interval 312. As a result, the first remote unit 300 and the second remote unit 302, which are separated by the TA-defined distance of 78 m, will become adjacent. In this regard, the likelihood of adjacency between the first remote unit 300 and the second remote unit 302 is inversely related to the TA-defined distance, but proportionally related to the predefined velocity 310 and the predefined interval 312. The longer the TA-defined distance is, the less likely the first remote unit 300 and the second remote unit 302 are adjacent. In contrast, the higher the predefined velocity 310 and the longer the predefined interval 312, the more likely the first remote unit 300 and the second remote unit 302 are adjacent. If the first remote unit 300 and the second remote unit 302 are separated by a relatively shorter TA-defined distance, for example less than one TA distance in air, it may be necessary to further separate the assigned unique identification temporal delays 204(1)-204(N) by more than one predefined TA step.

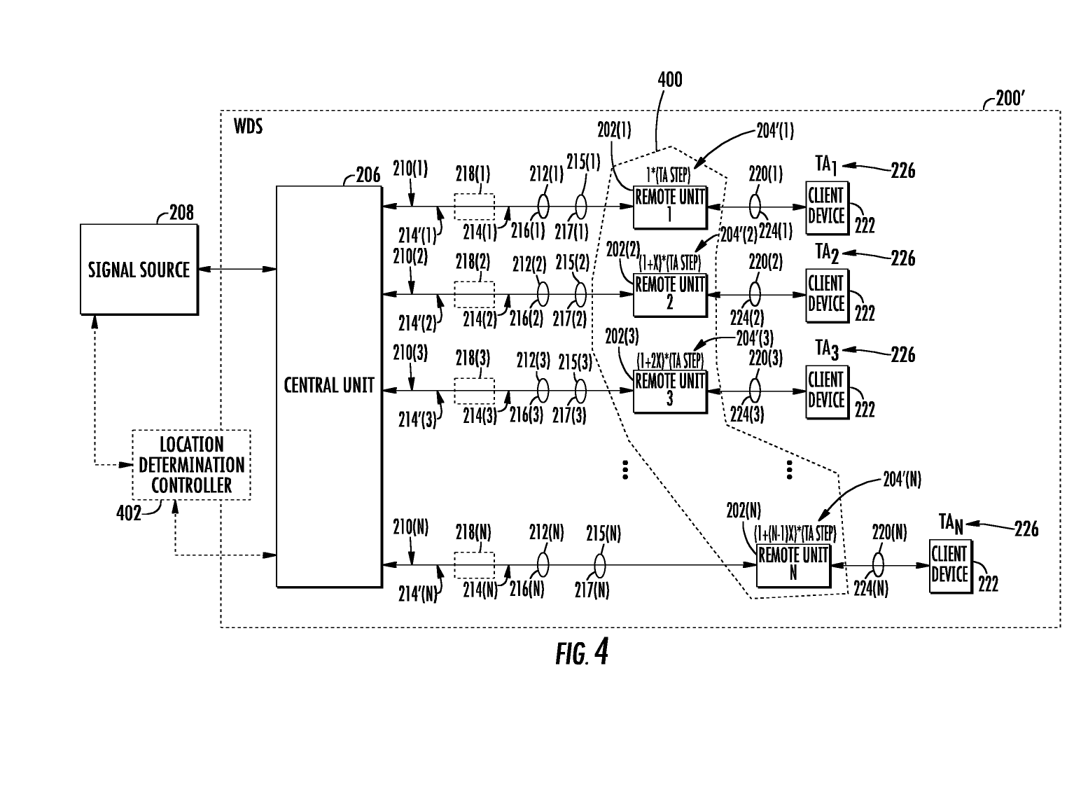

In this regard, FIG. 4 is a schematic diagram of an exemplary WDS 200′ in which the remote units 202(1)-202(N) of FIG. 2 are determined to be adjacent and can be uniquely identified by a plurality of assigned unique identification temporal delays 204′(1)-204′(N) that are separated between each other by more than one predefined TA step. Common elements between FIGS. 2 and 4 are shown therein with common element numbers and will not be re-described herein.

With reference to FIG. 4, the remote units 202(1)-202(N) are logically organized into a sequential queue 400. In a non-limiting example, the remote units 202(1)-202(N) are organized according to an ascending order in the sequential queue 400. In this regard, the remote unit 202(1) is the beginning remote unit in the sequential queue 400, the remote unit 202(2) is the second remote unit in the sequential queue 400, and the remote unit 202(N) is the last remote unit in the sequential queue 400. In the sequential queue 400, the remote unit 202(1) is the immediate preceding remote unit to the remote unit 202(2), the remote unit 202(2) is the immediate preceding remote unit to the remote unit 202(3), and the remote unit 202(N-1) (not shown) is the immediate preceding remote unit to the remote unit 202(N).

Since the remote units 202(1)-202(N) are determined to be adjacent, the client device 308 of FIG. 3 is able to move from the remote unit 202(1) to the remote unit 202(2) at the predefined velocity 310 and within the predefined interval 312. Likewise, the client device 308 is also able to move from the remote unit 202(2) to the remote unit 202(3) at the predefined velocity 310 and within the predefined interval 312. The client device 308 is also able to move from the remote unit 202(N-1) to the remote unit 202(N) at the predefined velocity 310 and within the predefined interval 312. According to the non-limiting example discussed with reference to FIG. 3, if the client device 308 is moving at the predefined velocity 310 of 2.2 m/s, the client device 308 will be able to travel 110 m within the predefined interval 312 of 50 s. In this regard, for the remote units 202(1)-202(N) to be adjacent to each other in the sequential queue 400, the respective TA-defined distance between each pair of the remote units 202(1)-202(N) shall be less than 110 m. That is, the remote unit 202(1) is located within 110 m of the TA-defined distance from the remote unit 202(2), the remote unit 202(2) is located within 110 m of the TA-defined distance from the remote unit 202(3), and the remote unit 202(N-1) is located within 110 m of the TA-defined distance from the remote unit 202(N).

To help overcome possible uplink propagation delay variations associated with the uplink communications signals 214(1)-214(N), a specified temporal delay separation X is defined to be more than one predefined TA step (X>1*(TA step)). The specified temporal delay separation X may be set according to environments in which the remote units 202(1)-202(N) are deployed. In a non-limiting example, the specified temporal delay separation X may be determined based on in-field measurements or experimental simulations.

With continuing reference to FIG. 4, assignment of the assigned unique identification temporal delays 204′(1)-204′(N) starts with the beginning remote unit 202(1) in the sequential queue 400. The beginning remote unit, which is the remote unit 202(1), is assigned the assigned unique identification temporal delay 204′(1) that is greater than or equal to one predefined TA step. Each of the subsequent remote units 202(2)-202(N) in the sequential queue 400 is then assigned a respective assigned unique identification temporal delay that differs from the respective assigned unique identification temporal delay of the immediate preceding remote unit in the sequential queue 400 by greater than or equal to the specified temporal delay separation X.

For example, if the assigned unique identification temporal delay 204′(1) of the beginning remote unit 202(1) is one predefined TA step (1*(TA step)), the assigned unique identification temporal delay 204′(2) of the subsequent remote unit 202(2) shall differ from the assigned unique identification temporal delay 204′(1) by at least the specified temporal delay separation X. In other words, the assigned unique identification temporal delay 204′(2) shall at least be (1+X)*(TA step). The assigned unique identification temporal delay 204′(3) of the subsequent remote unit 202(3) shall differ from the assigned unique identification temporal delay 204′(2) by at least the specified temporal delay separation X. In other words, the assigned unique identification temporal delay 204′(3) shall at least be (1+2X)*(TA step). Likewise, the assigned unique identification temporal delay 204′(N) of the subsequent remote unit 202(N) shall differ from the assigned unique identification temporal delay 204′(N-1) (not shown) by at least the specified temporal delay separation X. In other words, the assigned unique identification temporal delay 204′(N) shall at least be (1+(N−1)X)*(TA step).

In a non-limiting example, the specified delay separation X may need to be three predefined TA steps (3*(TA step)) to provide adequate temporal delay separations between the plurality of assigned unique identification temporal delays 204′(1)-204′(N). Accordingly, if the assigned unique identification temporal delay 204′(1) is 1*(TA step), the assigned unique identification temporal delay 204′(2) will be four predefined TA steps (4*(TA step)), the assigned unique identification temporal delay 204′(3) will be seven predefined TA steps (7*(TA step)), and so on.

In this regard, in the examples previously described with reference to FIG. 2, if the TA 226 assigned to the client device 222 is 0.6*(TA step) and the uplink communications signal 214(1) experiences an additional delay that is equal to 0.8*(TA step) over the uplink wireless signal path 224(1), then the uplink propagation delay will increase from 0.6*(TA step) to 1.4*(TA step). As a result, the total delay of the delayed uplink communications signal 214′(1) will increase from 1.6*(TA step) to 2.4*(TA step). By subtracting the TA 226 from the total delay of the delayed uplink communications signal 214′(1), the signal source 208 will determine that the assigned unique identification temporal delay is 1.8*(TA step). Since the assigned unique identification temporal delays 204′(1)-204′(2) of the remote units 202(1)-202(2) are now 1*(TA step) and 4*(TA step), respectively, the signal source 208 will be able to definitively identify the remote unit 202(1) based on the determined assigned unique identification temporal delay of 1.8*(TA step), even if the determined assigned unique identification temporal delay is rounded up to 2*(TA step). Hence, the chances of the signal source 208 misidentifying the remote units 202(1)-202(N) due to uplink propagation delay variations associated with the uplink communications signals 214(1)-214(N) can be reduced.

With continuing reference to FIG. 4, a location determination controller 402 may be configured to receive the delayed uplink communications signals 214′(1)-214′(N) over the uplink signal paths 216(1)-216(N), respectively. In a non-limiting example, the location determination controller 402 may be collocated with the central unit 206 or the signal source 208, or provided between the central unit 206 and the signal source 208. The location determination controller 402 may be configured to retrieve the TAs 226 from the signal source 208 and the assigned unique identification temporal delays 204′(1)-204′(N) from the central unit 206. In this regard, the location determination controller 402 has the knowledge about the TAs 226 assigned to the client devices 222 by the signal source 208. In a non-limiting example, the location determination controller 402 may retrieve the TAs 226 from cellular network entities such as network management system (NMS), operation system server (OSS), and/or operation and maintenance (OAM). The location determination controller 402 also has the knowledge about the assigned unique identification temporal delays 204′(1)-204′(N) assigned to the remote units 202(1)-202(N) by the central unit 206. Hence, the location determination controller 402 may be configured to determine the assigned unique identification temporal delays 204′(1)-204′(N) based on the delayed uplink communications signals 214′(1)-214′(N). As a result, the location determination controller 402 can uniquely identify the remote units 202(1)-202(N) based on the assigned unique identification temporal delays 204′(1)-204′(N).

In a non-limiting example, each of the delay elements 218(1)-218(N) may include digital circuitry (not shown) to delay a respective uplink communications signal among the uplink communications signals 214(1)-214(N) and/or a respective downlink communications signal among the downlink communications signals 210(1)-210(N) via digital signal processing. In another non-limiting example, each of the delay elements 218(1)-218(N) may include data buffers (not shown) to delay the uplink communications signals 214(1)-214(N) and/or the downlink communications signals 210(1)-210(N). In another non-limiting example, the WDS 200′ may be an optical fiber-based WDS. The downlink signal paths 212(1)-212(N) may be optical fiber-based downlink signal paths and the uplink signal paths 216(1)-216(N) may be optical fiber-based uplink signal paths. In this regard, the delay elements 218(1)-218(N) may be optical fiber-based delay elements that are provided in the optical fiber-based uplink signal paths and assigned to the remote units 202(1)-202(N), respectively. Each of the optical fiber-based delay elements is configured to delay a respective uplink communications signal communicated on a respective assigned optical fiber-based uplink signal path by the assigned unique identification temporal delay. For example, it may be possible to delay the respective uplink communications signal by the assigned unique identification temporal delay via increasing respective length of the respective assigned optical fiber-based uplink signal path.

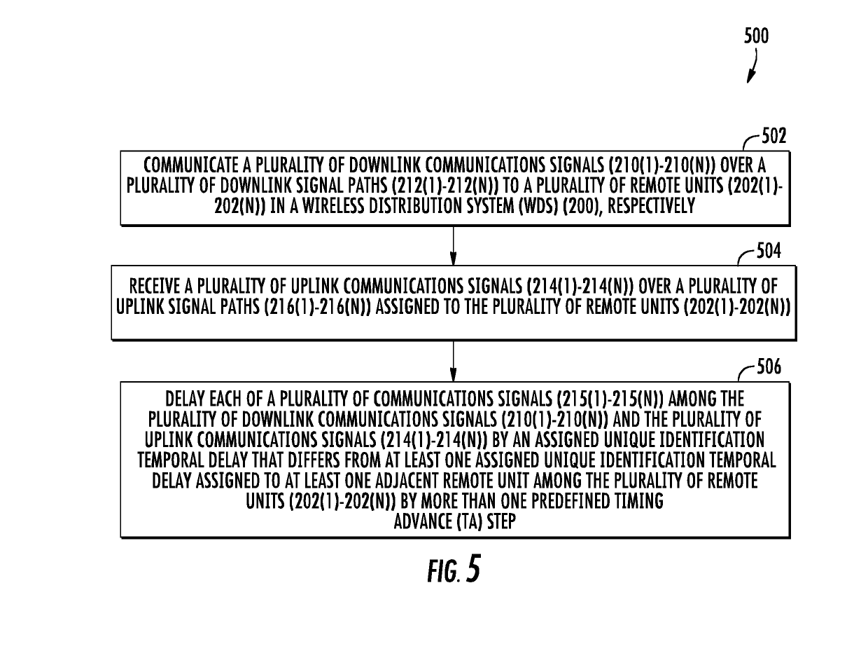

FIG. 5 is a flowchart of an exemplary remote unit identification process 500 that may be employed to identify the remote units 202(1)-202(N) in the WDS 200′ of FIG. 4. With reference to FIG. 5, the central unit 206 communicates the downlink communications signals 210(1)-210(N) over the downlink signal paths 212(1)-212(N) to the remote units 202(1)-202(N) in the WDS 200′ (block 502). The central unit 206 also receives the uplink communications signals 214(1)-214(N) over the uplink signal paths 216(1)-216(N) assigned to the remote units 202(1)-202(N) (block 504). Each of the communications signals 215(1)-215(N) among the downlink communications signals 210(1)-210(N) and the uplink communications signals 214(1)-214(N) is delayed by an assigned unique identification temporal delay that differs from at least one assigned unique identification temporal delay assigned to at least one adjacent remote unit among the remote units 202(1)-202(N) by more than one predefined TA step (block 506).

According to previous discussions in FIG. 4, the remote units 202(1)-202(N) are determined to be adjacent remote units. As a result, the respective assigned unique identification temporal delays of a remote unit in the sequential queue 400 differ from the respective assigned unique identification temporal delay of the immediate preceding remote unit in the sequential queue 400 by at least the specified temporal delay separation X. However, in some WDSs, a remote unit among the remote units 202(1)-202(N) may be adjacent to some of the remote units 202(1)-202(N) and non-adjacent to other remote units among the remote units 202(1)-202(N). As such, it may be desired to separate the assigned unique identification temporal delays between non-adjacent remote units with less than the specified temporal delay separation X to reduce overall propagation delay of the uplink communications signals 214(1)-214(N).

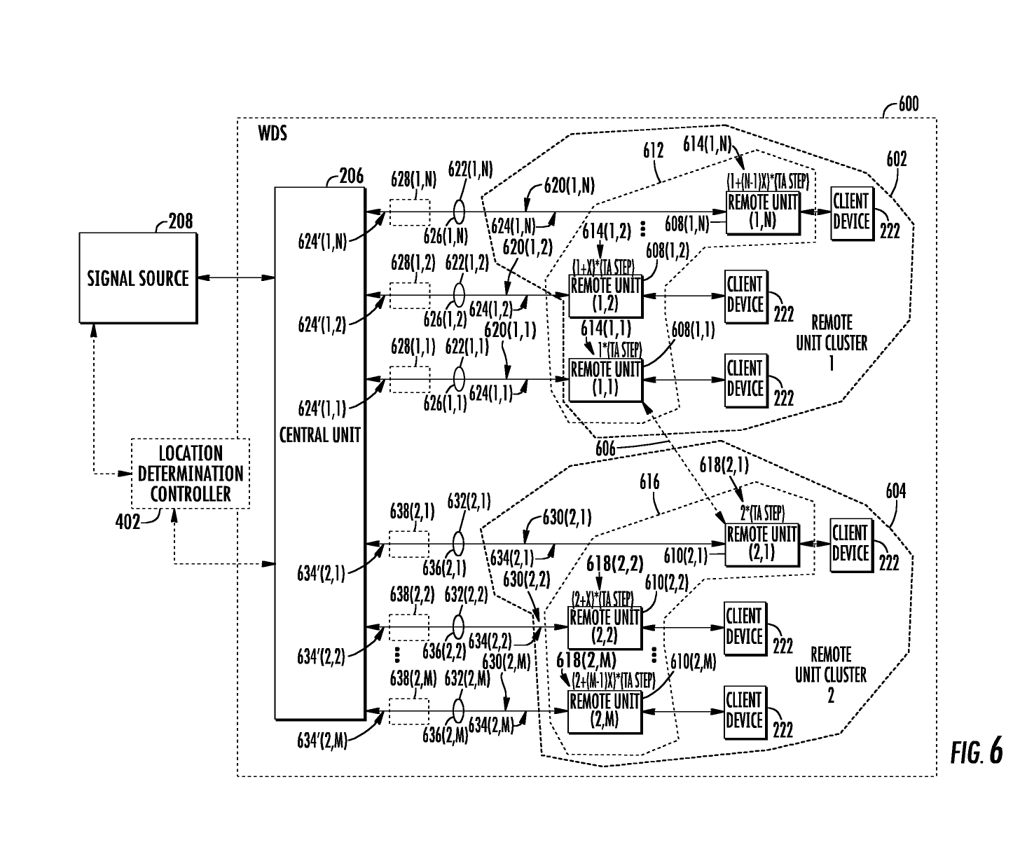

In this regard, FIG. 6 is a schematic diagram of an exemplary WDS 600 in which at least one first remote unit cluster 602 and at least one second remote unit cluster 604 are separated by a TA-defined distance 606 that the client device 308 of FIG. 3 is unable to traverse at the predefined velocity 310 within the predefined interval 312. As such, based on the discussions with reference to FIG. 3, the first remote unit cluster 602 and the second remote unit cluster 604 are non-adjacent remote unit clusters. In a non-limiting example, the TA-defined distance 606 is greater than or equal to two TA distances in air, which is approximately one hundred fifty-six meters (156 m) according to Equation 1.1 above. The predefined velocity 310 and the predefined interval 312 are 2.2 m/s and 50 s, respectively. Common elements between FIGS. 4 and 6 are shown therein with common element numbers and will not be re-described herein.

With reference to FIG. 6, the first remote unit cluster 602 includes one or more first remote units 608(1,1)-608(1,N) that are adjacent remote units. The second remote unit cluster 604 includes one or more second remote units 610(2,1)-610(2,M) that are adjacent remote units. Since the first remote unit cluster 602 is non-adjacent to the second remote unit cluster 604, all of the one or more first remote units 608(1,1)-608(1,N) in the first remote unit cluster 602 are non-adjacent to all of the one or more second remote units 608(2,1)-608(2,M) in the second remote unit cluster 604. In other words, all of the one or more first remote units 608(1,1)-608(1,N) in the first remote unit cluster 602 are separated from all of the one or more second remote units 608(2,1)-608(2,M) in the second remote unit cluster 604 by at least the TA-defined distance 606.

The one or more first remote units 608(1,1)-608(1,N) are logically organized into a first sequential queue 612. In a non-limiting example, the one or more first remote units 608(1,1)-608(1,N) are organized according to an ascending order in the first sequential queue 612. In this regard, the first remote unit 608(1,1) is the beginning first remote unit in the first sequential queue 612 and the first remote unit 608(1,N) is the last remote unit in the first sequential queue 612. In the first sequential queue 612, the first remote unit 608(1,1) is the immediate preceding remote unit to the first remote unit 608(1,2), the first remote unit 608(1,2) is the immediate preceding remote unit to the first remote unit 608(1,3) (not shown), and the first remote unit 608(1,N-1) (not shown) is the immediate preceding remote unit to the first remote unit 608(1,N).

With continuing reference to FIG. 6, the one or more first remote units 608(1,1)-608(1,N) are assigned one or more assigned first unique identification temporal delays 614(1,1)-614(1,N), respectively. Assignment of the one or more assigned first unique identification temporal delays 614(1,1)-614(1,N) starts with the beginning first remote unit 608(1,1) at a head of the first sequential queue 612. The beginning first remote unit 608(1,1) is assigned the assigned first unique identification temporal delay 614(1,1) that is greater than or equal to one predefined TA step. Each of the subsequent first remote units 608(1,2)-608(1,N) in the first sequential queue 612 is then assigned a respective assigned first unique identification temporal delay that differs from the respective assigned first unique identification temporal delay of the immediate preceding remote unit in the first sequential queue 612 by at least the specified temporal delay separation X.

For example, if the assigned first unique identification temporal delay 614(1,1) of the beginning first remote unit 608(1,1) is 1*(TA step), the assigned first unique identification temporal delay 614(1,2) of the first remote unit 608(1,2) shall differ from the assigned first unique identification temporal delay 614(1,1) by the specified temporal delay separation X. In other words, the assigned first unique identification temporal delay 614(1,2) shall be (1+X)*(TA step). Likewise, the assigned first unique identification temporal delay 614(1,N) of the first remote unit 608(1,N) shall differ from the assigned first unique identification temporal delay 614(1,N-1) (not shown) by the specified temporal delay separation X. In other words, the assigned first unique identification temporal delay 614(1,N) shall be (1+(N−1)X)*(TA step). In a non-limiting example, if the specified temporal delay separation X is 3*(TA step) and the assigned first unique identification temporal delay 614(1,1) is 1*(TA step), the assigned first unique identification temporal delay 614(1,2) will be 4*(TA step), and so on.

The one or more second remote units 610(2,1)-610(2,M) are logically organized into a second sequential queue 616. In a non-limiting example, the one or more second remote units 610(2,1)-610(2,M) are organized according to an ascending order in the second sequential queue 616. In this regard, the second remote unit 610(2,1) is the beginning second remote unit in the second sequential queue 616 and the second remote unit 610(2,M) is the last remote unit in the second sequential queue 616. In the second sequential queue 616, the second remote unit 610(2,1) is the immediate preceding remote unit to the second remote unit 610(2,2), the second remote unit 610(2,2) is the immediate preceding remote unit to the second remote unit 610(2,3) (not shown), and the second remote unit 610(2,M-1) (not shown) is the immediate preceding remote unit to the second remote unit 610(2,M).

With continuing reference to FIG. 6, the one or more second remote units 610(2,1)-610(2,M) are assigned one or more assigned second unique identification temporal delays 618(2,1)-618(2,M), respectively. Assignment of the one or more assigned second unique identification temporal delays 618(2,1)-618(2,M) starts with the beginning second remote unit 610(2,1) at a head of the second sequential queue 616. In a non-limiting example, the beginning second remote unit 610(2,1) is separated from the beginning first remote unit 608(1,1) by the TA-defined distance 606. As such, the beginning second remote unit 610(2,1) may be assigned the assigned second unique identification temporal delay 618(2,1) that differs from the assigned first unique identification temporal delay 614(1,1) of the beginning first remote unit 608(1,1) in the first remote unit cluster 602 by 1*(TA step). Since the assigned first unique identification temporal delay 614(1,1) of the beginning first remote unit 608(1,1) in the first remote unit cluster 602 is set to 1*(TA step), the assigned second unique identification temporal delay 618(2,1) may be 2*(TA step). Each of the subsequent remote units 610(2,2)-610(2,M) in the second sequential queue 616 is then assigned a respective assigned second unique identification temporal delay that differs from the respective assigned second unique identification temporal delay of the immediate preceding remote unit in the second sequential queue 616 by at least the specified temporal delay separation X.

For example, if the assigned second unique identification temporal delay 618(2,1) of the beginning second remote unit 610(2,1) is 2*(TA step), the assigned second unique identification temporal delay 618(2,2) of the second remote unit 610(2,2) shall differ from the assigned second unique identification temporal delay 618(2,1) by the specified temporal delay separation X. In other words, the assigned second unique identification temporal delay 618(2,2) shall be (2+X)*(TA step). Likewise, the assigned second unique identification temporal delay 618(2,M) of the second remote unit 610(2,M) shall differ from the assigned second unique identification temporal delay 618(2,M-1) (not shown) by at least the specified temporal delay separation X. In other words, the assigned second unique identification temporal delay 618(2,M) shall be at least (2+(M−1)X)*(TA step). In a non-limiting example, if the specified temporal delay separation X is 3*(TA step) and the assigned second unique identification temporal delay 618(2,1) is 2*(TA step), then the assigned second unique identification temporal delay 618(2,2) will be 5*(TA step), and so on.

With continuing reference to FIG. 6, the central unit 206 is configured to communicate one or more first downlink communications signals 620(1,1)-620(1,N) over one or more first downlink signal paths 622(1,1)-622(1,N) to the one or more first remote units 608(1,1)-608(1,N), respectively. The central unit 206 is also configured to receive one or more first uplink communications signals 624(1,1)-624(1,N) over one or more first uplink signal paths 626(1,1)-626(1,N) from the one or more first remote units 608(1,1)-608(1,N), respectively. The one or more first downlink signal paths 622(1,1)-622(1,N) and the one or more first uplink signal paths 626(1,1)-626(1,N) are disposed between the one or more first remote units 608(1,1)-608(1,N) and the central unit 206.

The WDS 600 also includes one or more first delay elements 628(1,1)-628(1,N) provided in the one or more first uplink signal paths 626(1,1)-626(1,N) and assigned to the one or more first remote units 608(1,1)-608(1,N), respectively. Each of the one or more first delay elements 628(1,1)-628(1,N) is configured to delay a respective first uplink communications signal among the one or more first uplink communications signals 624(1,1)-624(1,N) by a respective assigned first unique identification temporal delay among the one or more assigned first unique identification temporal delays 614(1,1)-614(1,N). As such, the location determination controller 402 will receive one or more delayed first uplink communications signals 624′(1,1)-624′(1,N). The one or more delayed first uplink communications signals 624′(1,1)-624′(1,N) are the same as the one or more first uplink communications signals 624(1,1)-624(1,N) but are delayed by the one or more first delay elements 628(1,1)-628(1,N) according to the one or more assigned first unique identification temporal delays 614(1,1)-614(1,N). The location determination controller 402 can analyze the one or more delayed first uplink communications signals 624′(1,1)-624′(1,N) to determine the one or more assigned first unique identification temporal delays 614(1,1)-614(1,N), respectively. The location determination controller 402 can then uniquely identify the one or more first remote units 608(1,1)-608(1,N) based on the one or more assigned first unique identification temporal delays 614(1,1)-614(1,N).

With continuing reference to FIG. 6, the central unit 206 is also configured to communicate one or more second downlink communications signals 630(2,1)-630(2,M) over one or more second downlink signal paths 632(2,1)-632(2,M) to the one or more second remote units 610(2,1)-610(2,M), respectively. The central unit 206 is also configured to receive one or more second uplink communications signals 634(2,1)-634(2,M) over one or more second uplink signal paths 636(2,1)-636(2,M) from the one or more second remote units 610(2,1)-610(2,M), respectively. The one or more second downlink signal paths 632(2,1)-632(2,M) and the one or more second uplink signal paths 636(2,1)-636(2,M) are disposed between the one or more second remote units 610(2,1)-610(2,M) and the central unit 206.

The WDS 600 also includes one or more second delay elements 638(2,1)-638(2,M) provided in the one or more second uplink signal paths 636(2,1)-636(2,M) and assigned to the one or more second remote units 610(2,1)-610(2,M), respectively. Each of the one or more second delay elements 638(2,1)-638(2,M) is configured to delay a respective second uplink communications signal among the one or more second uplink communications signals 634(2,1)-634(2,M) by a respective assigned second unique identification temporal delay among the one or more assigned second unique identification temporal delays 618(2,1)-618(2,M). As such, the location determination controller 402 will receive one or more delayed second uplink communications signals 634′(2,1)-634′(2,M). The one or more delayed second uplink communications signals 634′(2,1)-634′(2,M) are the same as the one or more second uplink communications signals 634(2,1)-634(2,M) but are delayed by the one or more second delay elements 638(2,1)-638(2,M) according to the one or more assigned second unique identification temporal delays 618(2,1)-618(2,M). The location determination controller 402 can analyze the one or more delayed second uplink communications signals 634′(2,1)-634′(2,M) to determine the one or more assigned second unique identification temporal delays 618(2,1)-618(2,M), respectively. The location determination controller 402 can then uniquely identify the one or more second remote units 610(2,1)-610(2,M) based on the one or more assigned second unique identification temporal delays 618(2,1)-618(2,M).

As previously discussed in FIG. 3, the predefined interval 312 may be an interval between two consecutive examinations of an uplink communications signal 314 transmitted by the client device 308 occurring at times T₀ and T₁, respectively. In a non-limiting example, at time T₀, the location determination controller 402 analyzes the delayed first uplink communications signal 624′(1,1) and identifies the first remote unit 608(1,1) based on the assigned first unique identification temporal delay 614(1,1). If at time T₁, however, the location determination controller 402 instead identifies the second remote unit 610(2,1) based on Equation 2 above, the location determination controller 402 may challenge the identification made at time T₁ on the grounds that the client device 222 transmitting the delayed first uplink communications signals 624′(1,1) should not be able to traverse the TA-defined distance 606 (e.g., 256 m) at the predefined velocity 310 (e.g., 2.2 m/s) within the predefined interval 312 (e.g., 50 s). In a non-limiting example, the location determination controller 402 may reexamine the delayed uplink communications signal 214′(1,1) after another predefined interval 312.

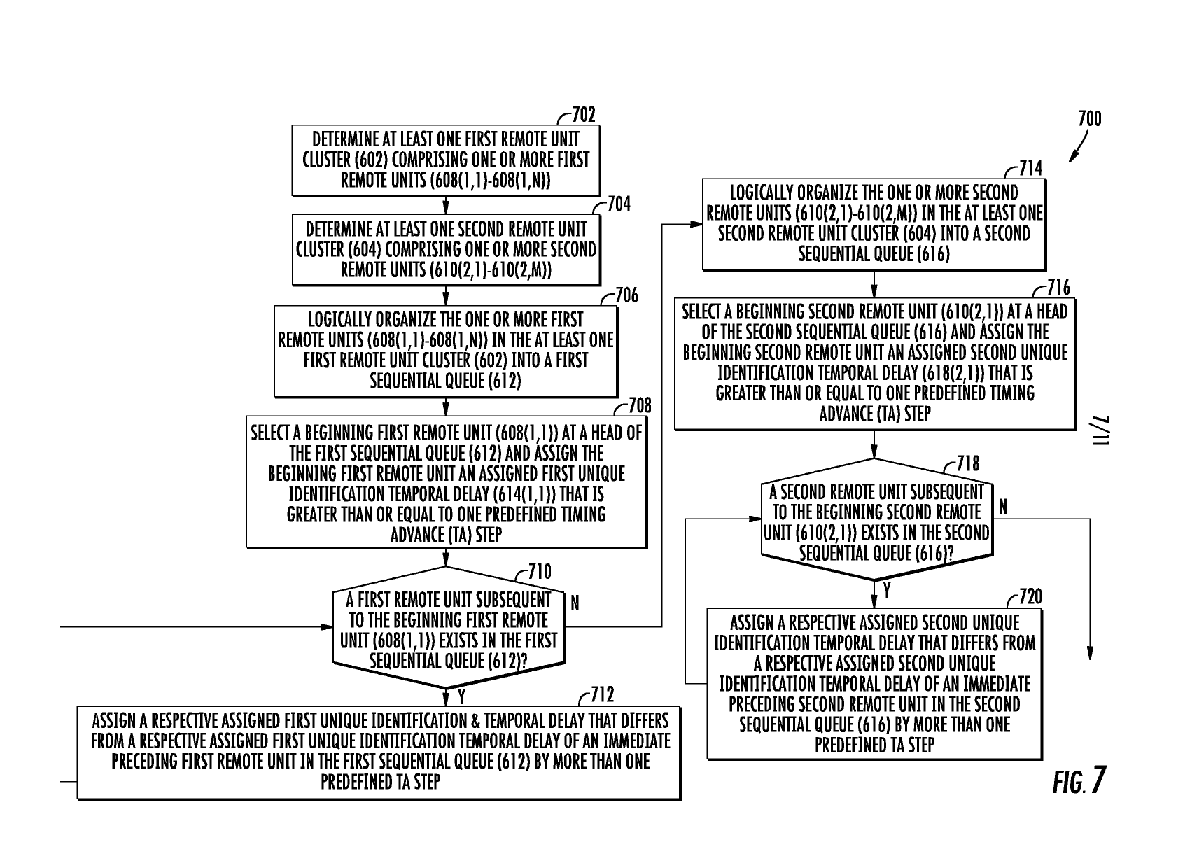

FIG. 7 is a flowchart of an exemplary remote unit identification process 700 that may be employed to assign unique identification temporal delays to the one or more first remote units 608(1,1)-608(1,N) and the one or more second remote units 610(2,1)-610(2,M) in the WDS 600 of FIG. 6. With reference to FIG. 7, the first remote unit cluster 602 is determined and the first remote unit cluster 602 includes the one or more first remote units 608(1,1)-608(1,N) (block 702). The second remote unit cluster 604 is also determined and the second remote unit cluster 604 includes the one or more second remote units 610(2,1)-610(2,M) (block 704). The one or more first remote units 608(1,1)-608(1,N) in the first remote unit cluster 602 are then logically organized into the first sequential queue 612 (block 706). Next, the beginning first remote unit 608(1,1) at the head of the first sequential queue 612 is selected and assigned the assigned first unique identification temporal delay 614(1,1) that is greater than or equal to one predefined TA step (block 708). A test is then performed to determine if a first remote unit subsequent to the beginning first remote unit 608(1,1) exists in the first sequential queue 612 (block 710). If a first remote unit subsequent to the beginning first remote unit 608(1,1) exists in the first sequential queue 612, the first remote unit subsequent to the beginning first remote unit 608(1,1) is assigned a respective assigned first unique identification temporal delay that differs from the respective assigned first unique identification temporal delay of an immediate preceding first remote unit in the first sequential queue 612 by more than one predefined TA step (block 712). The steps in blocks 710 and 712 are repeated until the one or more assigned first unique identification temporal delays 614(1,1)-614(1,N) are assigned to the one or more first remote units 608(1,1)-608(1,N) in the first remote unit cluster 602, respectively.

Subsequently, the one or more second remote units 610(2,1)-610(2,M) in the second remote unit cluster 604 are logically organized into the second sequential queue 616 (block 714). Next, the beginning second remote unit 610(2,1) at the head of the second sequential queue 616 is selected and assigned the assigned second unique identification temporal delay 618(2,1) that is greater than or equal to one predefined TA step (block 716). A test is then performed to determine if a second remote unit subsequent to the beginning second remote unit 610(2,1) exists in the second sequential queue 616 (block 718). If a second remote unit subsequent to the beginning second remote unit 610(2,1) exists in the second sequential queue 616, the second remote unit subsequent to the beginning second remote unit 610(2,1) is assigned a respective assigned second unique identification temporal delay that differs from the respective assigned second unique identification temporal delay of an immediate preceding second remote unit in the second sequential queue 616 by more than one predefined TA step (block 720). The steps in blocks 718 and 720 are repeated until the one or more assigned second unique identification temporal delays 618(2,1)-618(2,M) are assigned to the one or more second remote units 610(2,1)-610(2,M) in the second remote unit cluster 604, respectively.

With reference back to FIG. 2, each of the client devices 222 is assigned the TA 226 by the signal source 208 to accommodate for respective uplink propagation delay from the client device 222 to the signal source 208. The uplink communications signals 214(1)-214(N) are further delayed by the delay elements 218(1)-218(N) for the assigned unique identification temporal delays 204(1)-204(N), respectively, in addition to the respective TA 226. As a result, each of the delayed uplink communications signals 214′(1)-214′(N) will have a respective total delay as determined in Equation 2. Hence, it may also be possible to identify the location of the client device 222 with respect to a respective remote unit among the remote units 202(1)-202(N) in the WDS 200.

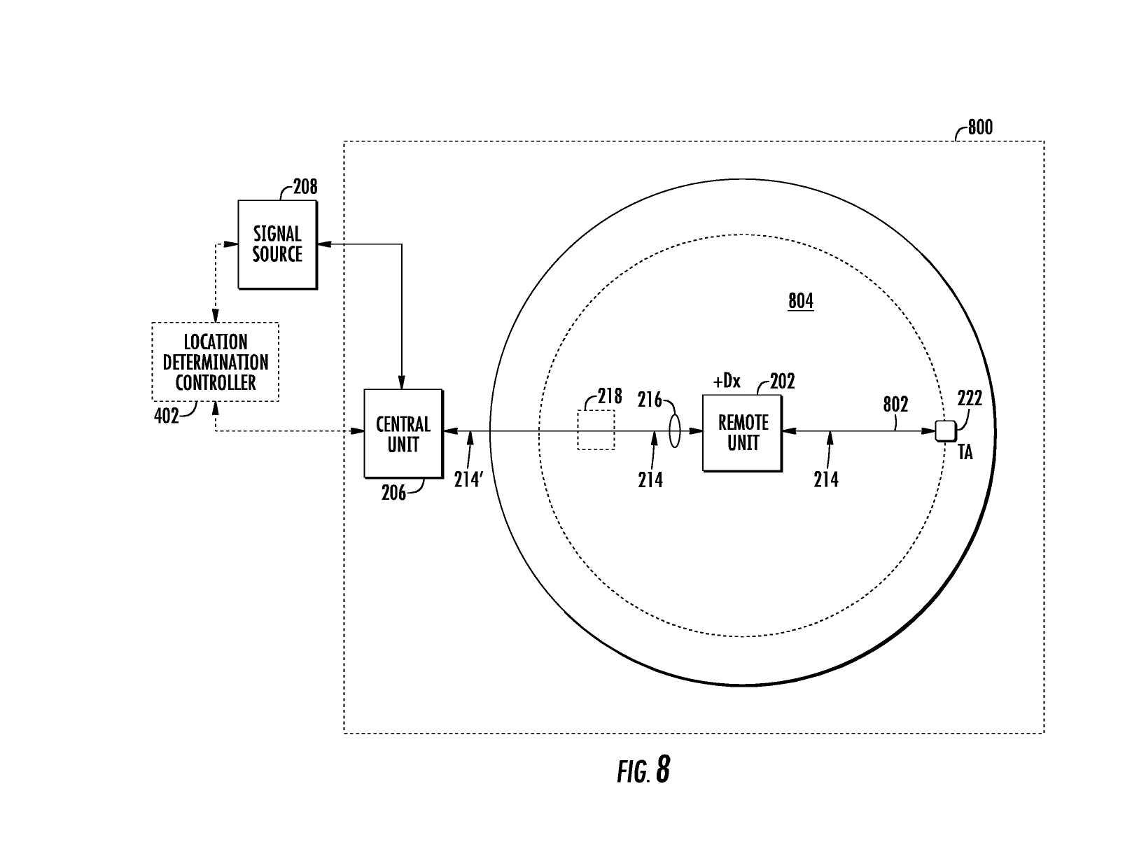

In this regard, FIG. 8 is a schematic diagram of an exemplary WDS 800 in which the central unit 206 of FIGS. 2 and 4 is configured to locate any of the client devices 222 within a determined radius from any of the remote units 202(1)-202(N). Common elements between FIGS. 2, 4, and 8 are shown therein with common element numbers and will not be re-described herein.

With reference to FIG. 8, a remote unit 202, which may be any of the remote units 202(1)-202(N), is assigned a unique fine-resolution identification temporal delay (D_{X}) that is not an integer multiple of the predefined TA step. In other words, a division of D_{X} by the predefined TA step will produce a remainder. The client device 222 is assigned the TA 226 (hereinafter referred to as “TA”) by the signal source 208. The remote unit 202 receives an uplink communications signal 214, which may be any of the uplink communications signals 214(1)-214(N), from the client device 222. The remote unit 202 provides the uplink communications signal 214 to the central unit 206 via an uplink signal path 216, which may be any of the uplink signal paths 216(1)-216(N). A delay element 218, which may be any of the delay elements 218(1)-218(N) delays the uplink communications signal 214 by the D_{X}. The central unit 206 receives a delayed uplink communications signal 214′, which may be any of the delayed uplink communications signals 214′(1)-214′(N), and determines a total temporal delay (D_{T}) that equals a sum of the D_{X} and the TA. According to the previous discussion in FIG. 4, the location determination controller 402 may retrieve the D_{T}, the DX, and the TA from the central unit 206 and the signal source 208. Subsequently, the location determination controller 402 may determine a radius 802 of the remote unit 202 based on the D_{T}, the DX, and the TA. The radius 802 of the remote unit 202 defines a region 804 in which the client device 222 is located.

In a non-limiting example, the D_{X} and the TA are configured to be eight point six predefined TA steps (8.6*(TA step)) and three tenths of the predefined TA step (0.3*(TA step)), respectively. Accordingly, the D_{T} corresponding to the delayed uplink communications signal 214′ will be eight point nine predefined TA steps (8.9*(TA step)) according to Equation 2 above. To determine the radius 802, the location determination controller 402 first rounds the D_{T} up to a nearest integer multiple of the predefined TA step. In this regard, the rounded-up D_{T} (D_{T}′) will equal nine predefined TA steps (9*(TA step)). Next, the location determination controller 402 determines a temporal delay offset by subtracting the D_{X} from the D_{T}′. In this regard, the temporal delay offset equals four tenths of the predefined TA step (0.4*(TA step)). The location determination controller 402 then multiplies the temporal delay offset by the speed of light to determine the radius 802. As previously discussed in FIG. 2, the predefined TA step equals 260.4×10⁻⁹ s and the speed of light equals 3×10⁸ m/s. As such, the radius 802 is approximately thirty-one point two meters (31.2 m). Hence, the location determination controller 402 is able to determine that the client device 222 is located in the region 804 from the remote unit 202.

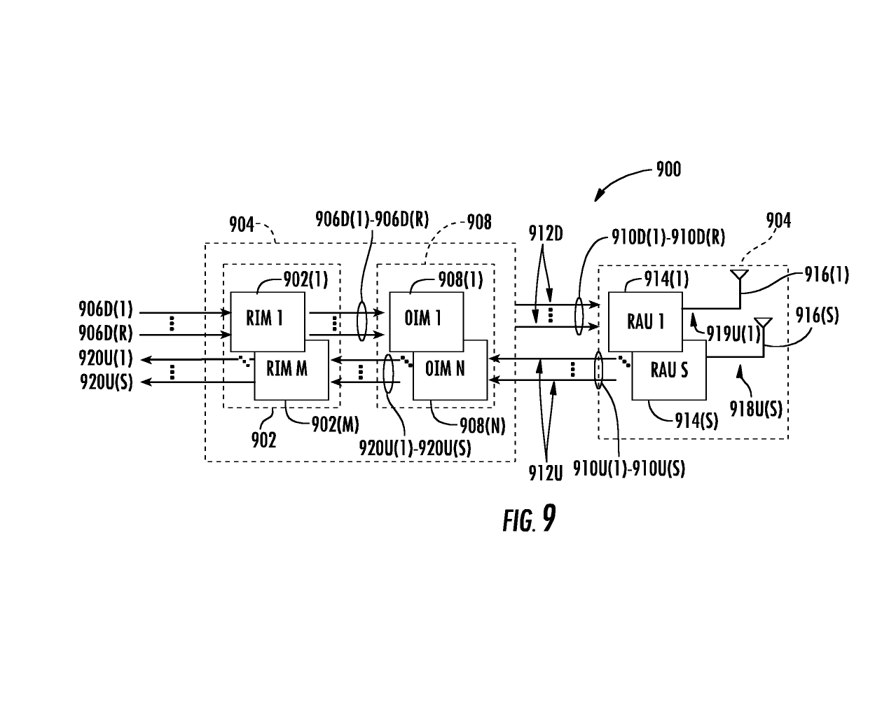

FIG. 9 is a schematic diagram of an exemplary WDS 900 that can be configured to function as the WDS 200 of FIG. 2, the WDS 200′ of FIG. 4, and the WDS 600 of FIG. 6. In this example, the WDS 900 is an optical fiber-based WDS. The WDS 900 includes an optical fiber for distributing communications services for multiple frequency bands. The WDS 900 in this example is comprised of three (3) main components. One or more radio interfaces provided in the form of a plurality of radio interface modules (RIMs) 902(1)-902(M) are provided in a central unit 904 to receive and process downlink electrical communications signals 906D(1)-906D(R) prior to optical conversion into downlink optical communications signals. The downlink electrical communications signals 906D(1)-906D(R) may be received from a base station (not shown), as an example. The RIMs 902(1)-902(M) provide both downlink and uplink interfaces for signal processing. The notations “1-R” and “1-M” indicate that any number of the referenced component, 1-R and 1-M, respectively, may be provided. The central unit 904 is configured to accept the RIMs 902(1)-902(M) as modular components that can easily be installed and removed or replaced in the central unit 904. In one non-limiting example, the central unit 904 is configured to support up to twelve (12) RIMs 902(1)-902(12). Each RIM 902(1)-902(M) can be designed to support a particular type of radio source or range of radio sources (i.e., frequencies) to provide flexibility in configuring the central unit 904 and the WDS 900 to support the desired radio sources.

For example, one RIM 902 may be configured to support the Personal Communication Services (PCS) radio band. Another RIM 902 may be configured to support the 800 MHz radio band. In this example, by inclusion of these RIMs 902, the central unit 904 could be configured to support and distribute communications signals on both PCS and LTE 700 radio bands, as an example. RIMs 902 may be provided in the central unit 904 that support any frequency bands desired, including but not limited to the US Cellular band, Personal Communication Services (PCS) band, Advanced Wireless Services (AWS) band, 700 MHz band, Global System for Mobile communications (GSM) 900, GSM 1800, and Universal Mobile Telecommunications System (UMTS). The RIMs 902(1)-902(M) may also be provided in the central unit 904 that support any wireless technologies desired, including but not limited to Code Division Multiple Access (CDMA), CDMA200, 1xRTT, Evolution-Data Only (EV-DO), UMTS, High-speed Packet Access (HSPA), GSM, General Packet Radio Services (GPRS), Enhanced Data GSM Environment (EDGE), Time Division Multiple Access (TDMA), LTE, Integrated Digital Enhanced Network (iDEN), and Cellular Digital Packet Data (CDPD).

The RIMs 902(1)-902(M) may be provided in the central unit 904 that support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

With continuing reference to FIG. 9, the downlink electrical communications signals 906D(1)-906D(R) are provided to a plurality of optical interfaces provided in the form of optical interface modules (OIMs) 908(1)-908(N) in this embodiment to convert the downlink electrical communications signals 906D(1)-906D(R) into downlink optical communications signals 910D(1)-910D(R). The notation “1-N” indicates that any number of the referenced component 1-N may be provided. The OIMs 908 may be configured to provide one or more optical interface components (OICs) that contain optical to electrical (O/E) and electrical to optical (E/O) converters, as will be described in more detail below. The OIMs 908 support the radio bands that can be provided by the RIMs 902, including the examples previously described above.

The OIMs 908(1)-908(N) each include E/O converters to convert the downlink electrical communications signals 906D(1)-906D(R) into the downlink optical communications signals 910D(1)-910D(R). The downlink optical communications signals 910D(1)-910D(R) are communicated over downlink optical fiber communications medium 912D to a plurality of remote units 914(1)-914(S), which may be remote antenna units (“RAUs 914(1)-914(S)”). The notation “1-S” indicates that any number of the referenced component 1-S may be provided. O/E converters provided in the RAUs 914(1)-914(S) convert the downlink optical communications signals 910D(1)-910D(R) back into the downlink electrical communications signals 906D(1)-906D(R), which are provided to antennas 916(1)-916(S) in the RAUs 914(1)-914(S) to client devices (not shown) in the reception range of the antennas 916(1)-916(S).

E/O converters are also provided in the RAUs 914(1)-914(S) to convert uplink electrical communications signals 918U(1)-918U(S) received from client devices (not shown) through the antennas 916(1)-916(S) into uplink optical communications signals 910U(1)-910U(S). The RAUs 914(1)-914(S) communicate the uplink optical communications signals 910U(1)-910U(S) over an uplink optical fiber communications medium 912U to the OIMs 908(1)-908(N) in the central unit 904. The OIMs 908(1)-908(N) include O/E converters that convert the received uplink optical communications signals 910U(1)-910U(S) into uplink electrical communications signals 920U(1)-920U(S), which are processed by the RIMs 902(1)-902(M) and provided as uplink electrical communications signals 920U(1)-920U(S). The central unit 904 may provide the uplink electrical communications signals 920U(1)-920U(S) to a base station or other communications system.

Note that the downlink optical fiber communications medium 912D and uplink optical fiber communications medium 912U connected to each RAU 914(1)-914(S) may be a common optical fiber communications medium, wherein for example, wave division multiplexing (WDM) may be employed to provide the downlink optical communications signals 910D(1)-910D(R) and the uplink optical communications signals 910U(1)-910U(S) on the same optical fiber communications medium.

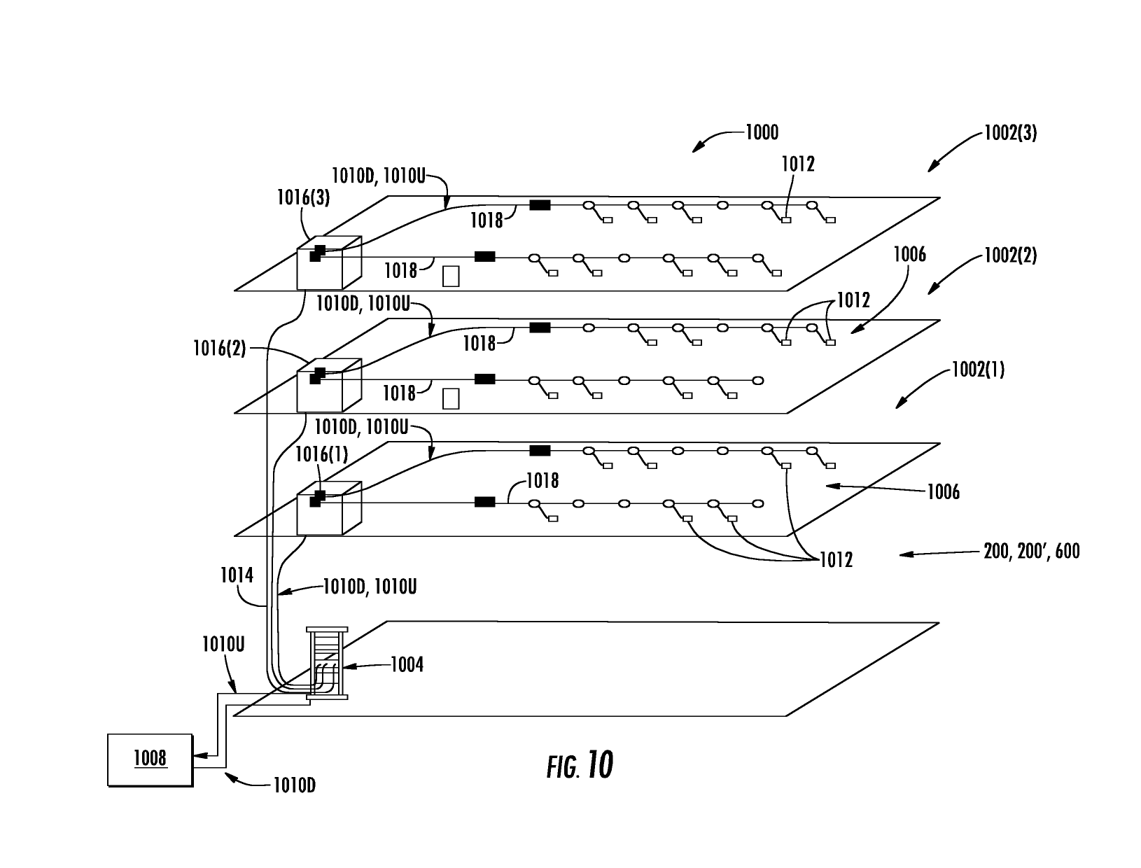

The WDS 200 of FIG. 2, the WDS 200′ of FIG. 4, and the WDS 600 of FIG. 6 may be provided in an indoor environment, as illustrated in FIG. 10. FIG. 10 is a partial schematic cut-away diagram of an exemplary building infrastructure 1000 in which the WDS 200 of FIG. 2, the WDS 200′ of FIG. 4, and the WDS 600 of FIG. 6 can be employed. The building infrastructure 1000 in this embodiment includes a first (ground) floor 1002(1), a second floor 1002(2), and a third floor 1002(3). The floors 1002(1)-1002(3) are serviced by a central unit 1004 to provide antenna coverage areas 1006 in the building infrastructure 1000. The central unit 1004 is communicatively coupled to a base station 1008 to receive downlink communications signals 1010D from the base station 1008. The central unit 1004 is communicatively coupled to a plurality of remote units 1012 to distribute the downlink communications signals 1010D to the remote units 1012 and to receive uplink communications signals 1010U from the remote units 1012, as previously discussed above. In this regard, each of the remote units 1012 is assigned a respective assigned unique identification temporal delay among the assigned unique identification temporal delays 204(1)-204(N). The downlink communications signals 1010D and the uplink communications signals 1010U communicated between the central unit 1004 and the remote units 1012 are carried over a riser cable 1014. The riser cable 1014 may be routed through interconnect units (ICUs) 1016(1)-1016(3) dedicated to each of the floors 1002(1)-1002(3) that route the downlink communications signals 1010D and the uplink communications signals 1010U to the remote units 1012 and also provide power to the remote units 1012 via array cables 1018.

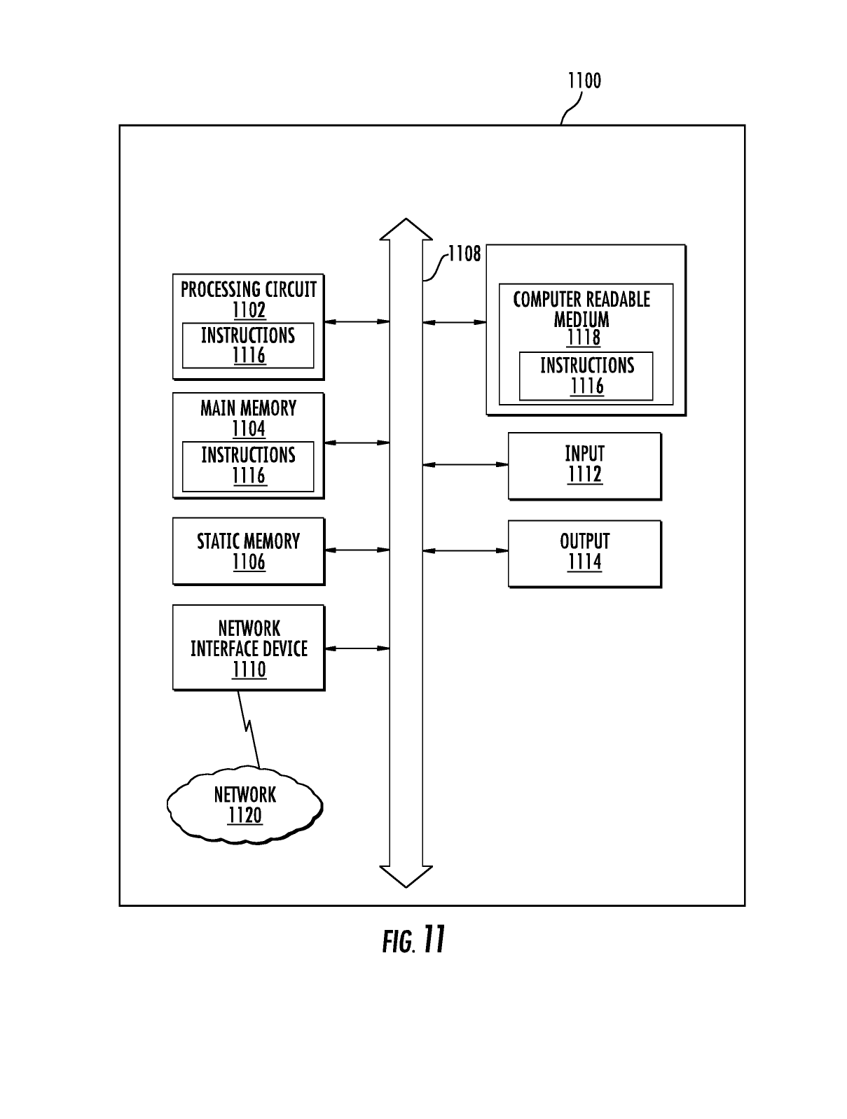

FIG. 11 is a schematic diagram illustrating additional details of an exemplary computer system 1100 that could be employed in the controllers discussed above, including, but not limited to, the location determination controller 402 of FIGS. 4 and 6. As discussed above, the location determination controller 402 of FIG. 4 is configured to uniquely identify the remote units 202(1)-202(N) in the WDS 200′. The location determination controller 402 of FIG. 6 is configured to uniquely identify the one or more first remote units 608(1,1)-608(1,N) and the one or more second remote units 610(2,1)-610(2,M) in the WDS 600. In this regard, the computer system 1100 is adapted to execute instructions from an exemplary computer-readable medium to perform these and/or any of the functions or processing described herein.

With reference to FIG. 11, the computer system 1100 may include a set of instructions that may be executed to uniquely identify the remote units 202(1)-202(N) in the WDS 200′ and to uniquely identify the one or more first remote units 608(1,1)-608(1,N) and the one or more second remote units 610(2,1)-610(2,M) in the WDS 600. The computer system 1100 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 1100 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server or a user's computer.

The computer system 1100 in this embodiment includes a processing circuit (“processor 1102”), a main memory 1104 (e.g., read-only memory (ROM), flash memory, dynamic random access memory (DRAM), such as synchronous DRAM (SDRAM), etc.), and a static memory 1106 (e.g., flash memory, static random access memory (SRAM), etc.), which may communicate with each other via a data bus 1108. Alternatively, the processor 1102 may be connected to the main memory 1104 and/or the static memory 1106 directly or via some other connectivity bus or connection. The main memory 1104 and the static memory 1106 may be any type of memory.

The processor 1102 may be a microprocessor, central processing unit, or the like. More particularly, the processor 1102 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 1102 is configured to execute processing logic in instructions for performing the operations and steps discussed herein.

The computer system 1100 may further include a network interface device 1110. The computer system 1100 also may or may not include an input 1112, configured to receive input and selections to be communicated to the computer system 1100 when executing instructions. The computer system 1100 also may or may not include an output 1114, including, but not limited to, a display, a video display unit (e.g., a liquid crystal display (LCD) or a cathode ray tube (CRT)), an alphanumeric input device (e.g., a keyboard), and/or a cursor control device (e.g., a mouse).

The computer system 1100 may or may not include a data storage device that includes instructions 1116 stored in a computer-readable medium 1118. The instructions 1116 may also reside, completely or at least partially, within the main memory 1104 and/or within the processor 1102 during execution thereof by the computer system 1100, the main memory 1104 and the processor 1102 also constituting the computer-readable medium 1118. The instructions 1116 may further be transmitted or received over a network 1120 via the network interface device 1110.

While the computer-readable medium 1118 is shown in an exemplary embodiment to be a single medium, the term “computer-readable medium” should be taken to include a single medium or multiple mediums (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical mediums, and magnetic mediums.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.), and the like.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1. A wireless distribution system (WDS), comprising:
a central unit configured to:
communicate a plurality of downlink communications signals over a plurality of downlink signal paths to a plurality of remote units in the WDS, respectively; and
receive a plurality of uplink communications signals over a plurality of uplink signal paths assigned to the plurality of remote units, the plurality of assigned uplink signal paths disposed respectively between the central unit and the plurality of remote units; and
a plurality of delay elements provided in a plurality of signal paths among the plurality of downlink signal paths and the plurality of uplink signal paths and assigned to the plurality of remote units, respectively;
wherein each of the plurality of delay elements is configured to delay a respective communications signal communicated on a respective assigned signal path by an assigned unique identification temporal delay that differs from at least one assigned unique identification temporal delay assigned to at least one adjacent remote unit among the plurality of remote units by more than one predefined timing advance (TA) step;
wherein an adjacent remote unit is a remote unit physically located from another remote unit among the plurality of remote units within a TA-defined distance that a client device can traverse at a predefined velocity within a predefined interval.

2. The WDS of claim 1, wherein:
the plurality of signal paths among the plurality of downlink signal paths and the plurality of uplink signal paths is comprised of the plurality of uplink signal paths;
the plurality of delay elements is provided in the plurality of uplink signal paths; and
each of the plurality of delay elements is configured to delay a respective uplink communications signal communicated on a respective assigned uplink signal path by the assigned unique identification temporal delay.

3. The WDS of claim 1, wherein:
the plurality of signal paths among the plurality of downlink signal paths and the plurality of uplink signal paths is comprised of the plurality of downlink signal paths;
the plurality of delay elements is provided in the plurality of downlink signal paths,; and
each of the plurality of delay elements is configured to delay a respective downlink communications signal communicated on a respective assigned downlink signal path by the assigned unique identification temporal delay.

4. The WDS of claim 1, wherein:
the plurality of signal paths among the plurality of downlink signal paths and the plurality of uplink signal paths is comprised of the plurality of uplink signal paths and the plurality of downlink signal paths;
the plurality of delay elements is provided in the plurality of uplink signal paths and the plurality of downlink signal paths; and
each of the plurality of delay elements is configured to:
delay a respective uplink communications signal communicated on a respective assigned uplink signal path by the assigned unique identification temporal delay; and
delay a respective downlink communications signal communicated on a respective assigned downlink signal path by the assigned unique identification temporal delay.

5. The WDS of claim 1, wherein the predefined TA step corresponds to a specified temporal duration.

6. The WDS of claim 1, wherein each of the plurality of delay elements is configured to delay the respective communications signal by the assigned unique identification temporal delay that is an integer multiple of the predefined TA step.

7. The WDS of claim 1, wherein the TA-defined distance is an integer multiple of a TA distance.

8. The WDS of claim 7, wherein the TA distance is a distance that light can traverse within one predefined TA step.

9. The WDS of claim 8, wherein the predefined TA step is equal to five hundred twenty point eight nanoseconds (520.8 ns).

10. The WDS of claim 7, wherein the TA distance is equal to seventy-eight meters (78 m).

11. The WDS of claim 1, wherein the predefined velocity is less than or equal to five miles per hour (5 MPH).

12. The WDS of claim 1, wherein each of the plurality of delay elements comprises digital circuitry configured to delay the respective communications signal communicated on the respective assigned signal path by the at least one assigned unique identification temporal delay via digital signal processing.

13. The WDS of claim 1, further comprising a location determination controller configured to:
receive a plurality of delayed uplink communications signals over the plurality of uplink signal paths, respectively, each of the plurality of delayed uplink communications signals corresponding to a respective total delay; and
for each of the plurality of delayed uplink communications signals:
determine a respective assigned unique identification temporal delay corresponding to the delayed uplink communications signal based on the respective total delay; and
identify a remote unit among the plurality of remote units based on the determined respective assigned unique identification temporal delay.

14. The WDS of claim 13, wherein the location determination controller is provided in the central unit.

15. The WDS of claim 13, wherein:
a remote unit among the plurality of remote units is configured to receive a respective uplink communications signal from a respective client device, the respective uplink communications signal comprising a TA corresponding to the respective client device;
a delay element among the plurality of delay elements is configured to delay the respective uplink communications signal by a unique fine-resolution identification temporal delay that can produce a remainder when divided by the predefined TA step; and
the location determination controller is further configured to:
receive a delayed uplink communications signal from the delay element;
determine a total temporal delay of the delayed uplink communications signal; and
determine a radius from the remote unit based on the total temporal delay as a region wherein the respective client device is located.

16. The WDS of claim 15, wherein the location determination controller is further configured to:
round the total temporal delay up to a nearest integer multiple of the predefined TA step;
calculate a temporal delay offset by subtracting the unique fine-resolution identification temporal delay from the rounded-up total temporal delay; and
determine the radius from the remote unit by multiplying the temporal delay offset and a speed of light.

17. The WDS of claim 1, wherein the central unit comprises:
a plurality of electrical-to-optical (E/O) converters configured to communicate the plurality of downlink communications signals over a plurality of optical fiber-based downlink signal paths to the plurality of remote units in the WDS, respectively; and
a plurality of optical-to-electrical (0/E) converters configured to receive the plurality of uplink communications signals over a plurality of optical fiber-based uplink signal paths assigned to the plurality of remote units.

18. The WDS of claim 17, further comprising a plurality of optical delay elements provided in the plurality of optical fiber-based uplink signal paths and assigned to the plurality of remote units, respectively, each of the plurality of optical delay elements configured to delay a respective uplink communications signal communicated on a respective assigned optical fiber-based uplink signal path by the assigned unique identification temporal delay by increasing respective length of the respective assigned optical fiber-based uplink signal path.

19. A method for identifying a plurality of remote units in a wireless distribution system (WDS), comprising:
communicating a plurality of downlink communications signals over a plurality of downlink signal paths to the plurality of remote units in the WDS, respectively;
receiving a plurality of uplink communications signals over a plurality of uplink signal paths assigned to the plurality of remote units; and
delaying each of a plurality of communications signals among the plurality of downlink communications signals and the plurality of uplink communications signals by an assigned unique identification temporal delay that differs from at least one assigned unique identification temporal delay assigned to at least one adjacent remote unit among the plurality of remote units by more than one predefined timing advance (TA) step.

20. The method of claim 19, further comprising delaying each of the plurality of uplink communications signals by the assigned unique identification temporal delay.

21. The method of claim 19, further comprising delaying each of the plurality of downlink communications signals by the assigned unique identification temporal delay.

22. The method of claim 19, further comprising delaying each of the plurality of uplink communications signals and each of the plurality of downlink communications signals by the assigned unique identification temporal delay.

23. The method of claim 19, further comprising:
receiving a plurality of delayed uplink communications signals over the plurality of uplink signal paths, respectively, each of the plurality of delayed uplink communications signals corresponding to a respective total delay; and
for each of the plurality of delayed uplink communications signals:
determining a respective assigned unique identification temporal delay corresponding to the delayed uplink communications signal based the respective total delay; and
identifying a remote unit among the plurality of remote units based on the determined respective assigned unique identification temporal delay.

24. The method of claim 19, further comprising:
logically organizing the plurality of remote units into a sequential queue having a beginning remote unit and one or more subsequent remote units, wherein each of the one or more subsequent remote units is adjacent to an immediate preceding remote unit in the sequential queue;
assigning the beginning remote unit an assigned unique identification temporal delay that is greater than or equal to the predefined TA step; and
assigning each of the one or more subsequent remote units a respective assigned unique identification temporal delay that differs from the respective assigned unique identification temporal delay of the immediate preceding remote unit in the sequential queue by more than one predefined TA step.

25. The method of claim 19, further comprising:
receiving a respective uplink communications signal among the plurality of uplink communications signals from a respective client device, the respective uplink communications signal comprising a TA corresponding to the respective client device;
delaying the respective uplink communications signal by a unique fine-resolution identification temporal delay that can produce a remainder when divided by the predefined TA step;
receiving the delayed uplink communications signal corresponding to a total temporal delay equal to a sum of the unique fine-resolution identification temporal delay and the TA; and
determining a radius from a remote unit based on the total temporal delay as a region wherein the respective client device is located.

26. The method of claim 25, further comprising:
rounding the total temporal delay up to a nearest integer multiple of the predefined TA step;
determining a temporal delay offset by subtracting the unique fine-resolution identification temporal delay from the rounded-up total temporal delay; and
determining the radius from the remote unit by multiplying the temporal delay offset and a speed of light.

27.-36. (canceled)
